(19) United States
(12) Patent Application Publication
(10) Pub. No.: US 2011/0149848 A1
(43) Pub. Date: Jun. 23, 2011

(54) HEADER COMPRESSION FOR RELAY NODES

(75) Inventors: Sai Yiu Duncan Ho, San Diego, CA (US); Fatih Ulupinar, San Diego, CA (US); Parag Arun Agashe, San Diego, CA (US); Rajat Prakash, La Jolla, CA (US); Osok Song, San Diego, CA (US)

(73) Assignee: QUALCOMM Incorporated, San Diego, CA (US)

(21) Appl. No.: 12/822,923

(22) Filed: Jun. 24, 2010

Related U.S. Application Data
(60) Provisional application No. 61/234,580, filed on Aug. 17, 2009.

(51) Int. Cl. H04W 40/00

(52) U.S. Cl. 370/328

(57) ABSTRACT

Systems and methodologies are described that facilitate compressing headers for relay nodes. In particular, a plurality of internet protocol (IP) headers, tunneling protocol headers, and/or other routing headers in a packet can be compressed to facilitate efficient communications of packets between relay nodes and/or a donor access point. An access point receiving packets to be compressed can provide a disparate access point with a compression context and an uncompressed packet. The disparate access point can generate a decompression context related to subsequent packets having similar header values and can store the decompression context with the context identifier. The access point can subsequently compress received packets having similar header values and communicate the compressed packets with the context identifier to the disparate access point. The disparate access point can apply the previously generated decompression context associated with the context identifier to decompress the packets.

### CLAIM OF PRIORITY UNDER 35 U.S.C. §119

The present Application for patent claims priority to Provisional Application No. 61/234,580 entitled “HEADER COMPRESSION OF UDP/IP/GTP HEADERS IN THE UN INTERFACE OF LTE RELAY ARCHITECTURE” filed Aug. 17, 2009, and assigned to the assignee hereof and hereby expressly incorporated by reference herein.

### BACKGROUND

1. Field

The following description relates generally to wireless communications, and more particularly to routing packets among multiple access points.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), and/or multi-carrier wireless specifications such as evolution data optimized (EV-DO), one or more revisions thereof, etc.

Generally, wireless multiple-access communication systems may simultaneously support communication for multiple mobile devices. Each mobile device may communicate with one or more access points (e.g., base stations) via transmissions on forward and reverse links. The forward link (or downlink) refers to the communication link from access points to mobile devices, and the reverse link (or uplink) refers to the communication link from mobile devices to access points. Further, communications between mobile devices and access points may be established via single-input single-output (SISO) systems, multiple-input single-output (MISO) systems, multiple-input multiple-output (MIMO) systems, and so forth. Access points, however, can be limited in geographic coverage area as well as resources such that mobile devices near edges of coverage and/or devices in areas of high traffic can experience degraded quality of communications from an access point.

Relay nodes can be provided to expand network capacity and coverage area by facilitating communication between mobile devices and access points. For example, a relay node can establish a backhaul link with a donor access point, which can provide access to a number of other relay nodes, and the relay node can establish an access link with one or more mobile devices or additional relay nodes. Thus, there can be multiple relay nodes in a communications path between a mobile device and access point. In certain relay node configurations (e.g., for internet protocol (IP) relay nodes), each relay node can add a header to a received packet to facilitate routing the received packet among the various relay nodes and/or among core network components. Similarly, a given responding packet can include various headers to be processed at each relay node to route the packet to a device related to the received packet. The various headers result in additional data transmitted between each node in a communications path, which can impact data throughput in the wireless network.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with facilitating compressing protocol headers to provide efficient communication among relay nodes. In particular, for example, a context identifier can be assigned to a received packet for association with at least a portion of data within the one or more headers in the received packet. The context identifier and packet can be provided to a corresponding relay node or other access point, in this example. In this regard, headers of subsequent packets having similar portions of data can be compressed and provided to the relay node or other access point along with the context identifier, and the relay node or other access point can decompress the headers based at least in part on the context identifier, for example. The portions of data can relate to static fields in the one or more headers, such as routing addresses, network addresses, and/or the like.

According to related aspects, a method is provided that includes receiving a packet from an access point including one or more compressed headers and a context identifier and determining a context related to decompressing the one or more compressed headers based at least in part on the context identifier. The method further includes decompressing the one or more compressed headers based at least in part on the context.

Another aspect relates to a wireless communications apparatus. The wireless communications apparatus can include at least one processor configured to obtain a packet from an access point including one or more compressed headers and a context identifier and associate a context with the packet for decompressing the one or more compressed headers based at least in part on the context identifier. The at least one processor is further configured to decompress the one or more compressed headers according to the context. The wireless communications apparatus also comprises a memory coupled to the at least one processor.

Yet another aspect relates to an apparatus. The apparatus includes means for receiving a packet from an access point including one or more compressed headers and means for retrieving a context identifier from the packet. The apparatus also includes means for determining a context related to decompressing the one or more compressed headers based at least in part on the context identifier and means for decompressing the one or more compressed headers based at least in part on the context.

Still another aspect relates to a computer program product, which can have a computer-readable medium including code for causing at least one computer to obtain a packet from an access point including one or more compressed headers and a context identifier and code for causing the at least one computer to associate a context with the packet for decompressing the one or more compressed headers based at least in part on the context identifier. The computer-readable medium can also comprise code for causing the at least one computer to decompress the one or more compressed headers according to the context.

Moreover, an additional aspect relates to an apparatus including a packet communicating component that receives a packet from an access point including one or more compressed headers and a context identifier determining component that retrieves a context identifier from the packet. The apparatus can further include a decompression context associating component that determines a context related to decompressing the one or more compressed headers based at least in part on the context identifier and a header decompressing component that decompresses the one or more compressed headers based at least in part on the context.

According to another aspect, a method is provided that includes receiving an initial packet from the wireless device or the core network component and generating the context for compressing headers based at least in part on a portion of one or more initial headers of the initial packet. The method further includes associating the context identifier with the context and communicating the context identifier and the initial packet to an access point.

Another aspect relates to a wireless communications apparatus. The wireless communications apparatus can include at least one processor configured to obtain a packet comprising one or more headers for routing the packet among one or more relay nodes from a wireless device or a core network component and determine a context identifier related to the packet. The at least one processor is further configured to discern a context for compressing the one or more headers based at least in part on the context identifier and compress the one or more headers based at least in part on the context. The wireless communications apparatus also comprises a memory coupled to the at least one processor.

Yet another aspect relates to an apparatus. The apparatus includes means for receiving a packet comprising one or more headers related to routing the packet from a wireless device or a core network component and means for determining a context identifier related to the packet. The apparatus also includes means for selecting a context for compressing the one or more headers based at least in part on the context identifier and means for compressing the one or more headers based at least in part on the context.

Still another aspect relates to a computer program product, which can have a computer-readable medium including code for causing at least one computer to obtain a packet comprising one or more headers for routing the packet among one or more relay nodes from a wireless device or a core network component and code for causing the at least one computer to determine a context identifier related to the packet based at least in part on the one or more headers. The computer-readable medium can also comprise code for causing the at least one computer to discern a context for compressing the one or more headers based at least in part on the context identifier and code for causing the at least one computer to compress the one or more headers based at least in part on the context.

Moreover, an additional aspect relates to an apparatus including a packet communicating component that receives a packet comprising one or more headers related to routing the packet from a wireless device or a core network component and a context identifier determining component that obtains a context identifier for the packet. The apparatus can further include a compression context associating component that discerns a context for compressing the one or more headers based at least in part on the context identifier and a header compressing component that compresses the one or more headers based at least in part on the context.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed and this description is intended to include all such aspects and their equivalents.

### BRIEF DESCRIPTION OF THE DRAWINGS

FIG. 1 is an illustration of an example wireless communications system that facilitates providing relays for wireless networks.

FIG. 2 is an illustration of an example wireless communications system that compresses packet headers for efficient communications among relay nodes.

FIG. 3 is an illustration of an example wireless communications system that provides a context identifier related to compressing downlink packets.

FIG. 4 is an illustration of an example wireless communications system that provides a context identifier related to compressing uplink packets.

FIG. 5 is an illustration of an example wireless communications system that facilitates compressing headers related to multiple relay nodes.

FIG. 6 is an illustration of an example wireless communications system that facilitates decompressing headers related to multiple relay nodes.

FIG. 7 is an illustration of an example wireless communications system that utilizes relay nodes to provide access to a wireless network.

FIG. 8 is an illustration of example protocol stacks that facilitate providing relay node functionality.

FIG. 9 is an illustration of an example methodology for decompressing compressed headers based at least in part on determining a context.

FIG. 10 is an illustration of an example methodology that generates a context for subsequently decompressing packets based on a context identifier.

FIG. 11 is an illustration of an example methodology for compressing headers based at least in part on determining a context.

FIG. 12 is an illustration of an example methodology that generates a context for subsequently compressing packets based on a context identifier.

FIG. 13 is an illustration of a wireless communication system in accordance with various aspects set forth herein.

FIG. 14 is an illustration of an example wireless network environment that can be employed in conjunction with the various systems and methods described herein.

FIG. 15 is an illustration of an example system that facilitates decompressing one or more headers according to a context identifier.

FIG. 16 is an illustration of an example system that facilitates compressing one or more headers according to a context identifier.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

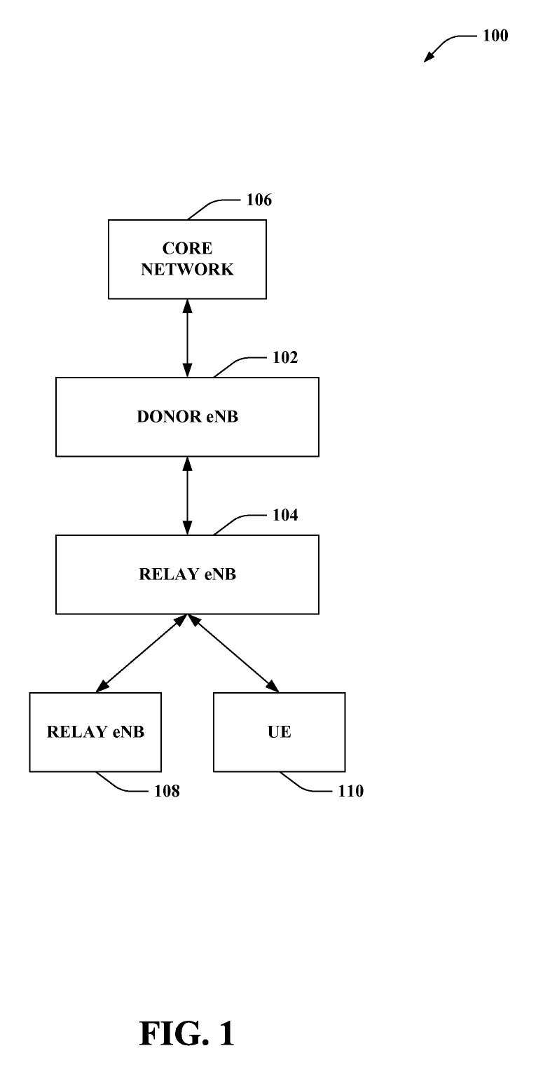

Referring to FIG. 1, a wireless communication system 100 is illustrated that facilitates providing relay functionality in wireless networks. System 100 includes a donor eNB 102 that provides one or more relay eNBs, such as relay eNB 104, with access to a core network 106. Similarly, relay eNB 104 can provide one or more disparate relay eNBs, such as relay eNB 108, or UEs, such as UE 110, with access to the core network 106 via donor eNB 102. Donor eNB 102, which can also be referred to as a cluster eNB, can communicate with the core network 106 over a wired or wireless backhaul link, which can be an LTE or other technology backhaul link. In one example, the core network 106 can be a 3GPP LTE or similar technology network.

Donor eNB 102 can additionally provide an access link for relay eNB 104, which can also be wired or wireless, LTE or other technologies, and the relay eNB 104 can communicate with the donor eNB 102 using a backhaul link over the access link of the donor eNB 102. Relay eNB 104 can similarly provide an access link for relay eNB 108 and/or UE 110, which can be a wired or wireless LTE or other technology link. In one example, donor eNB 102 can provide an LTE access link, to which relay eNB 104 can connect using an LTE backhaul, and relay eNB 104 can provide an LTE access link to relay eNB 108 and/or UE 110. Donor eNB 102 can connect to the core network 106 over a disparate backhaul link technology. Relay eNB 108 and/or UE 110 can connect to the relay eNB 104 using the LTE access link to receive access to core network 106, as described. A donor eNB and connected relay eNBs can be collectively referred to herein as a cluster.

According to an example, relay eNB 104 can connect to a donor eNB 102 at the link layer (e.g., media access control (MAC) layer), transport layer, application layer, and/or the like, as would a UE in conventional LTE configurations. In this regard, donor eNB 102 can act as a conventional LTE eNB requiring no changes at the link layer, transport layer, application layer, etc, or related interface (e.g., user-to-user (Uu), such as E-UTRA-Uu, user-to-network (Un), such as EUTRA-Un, etc.), to support the relay eNB 104. In addition, relay eNB 104 can appear to UE 110 as a conventional eNB in LTE configurations at the link layer, transport layer, application layer, and/or the like, such that no changes are required for UE 110 to connect to relay eNB 104 at the link layer, transport layer, application layer, etc., for example. In addition, relay eNB 104 can configure procedures for resource partitioning between access and backhaul link, interference management, idle mode cell selection for a cluster, and/or the like. It is to be appreciated that relay eNB 104 can connect to additional donor eNBs, in one example.

Thus, for example, relay eNB 104 can establish a connection with donor eNB 102 to receive access to one or more components in core network 106 (such as a mobility management entity (MME), serving gateway (SGW), packet data network (PDN) gateway (PGW), etc.). In an example, relay eNB 104 can obtain an internet protocol (IP) address from a PGW/SGW in the core network 106 (e.g., via donor eNB 102) for communicating therewith. In addition, UE 110 can establish a connection with relay eNB 104 to receive access to one or more similar components in core network 106. In this regard, for example, UE 110 can communicate IP packets to relay eNB 104 for providing to core network 106. Relay eNB 104 can obtain the IP packets, associate one or more additional headers with the packets related to relay eNB 104, and provide the packets to donor eNB 102. The additional headers can include an IP or user datagram protocol (UDP)/IP header related to relay eNB 104 and a corresponding component of core network 106, a general packet radio service (GPRS) tunneling protocol (GTP) header or similar header to facilitate routing of the packet to the component of core network 106 and/or routing of a responding packet to relay eNB 104, etc. Thus, donor eNB 102 can route the packets to a component of core network 106 related to relay eNB 104 (e.g., by adding another header and transmitting to core network 106).

Components of core network 106, for example, can route the packets within the core network 106 according to the various IP headers. Moreover, for example, core network 106 can construct packets for providing to UE 110 to include UDP/IP headers, GTP headers, etc., related to routing the packet to UE 110 through relay eNB 104. In an example, core network 106 can include an IP header related to UE 110 with the packet, as well as a UDP/IP and/or GTP header related to relay eNB 104, and/or similar header(s) related to donor eNB 102. Core network 106 can forward the packet with the headers to donor eNB 102. Donor eNB 102 can obtain the packet, remove the UDP/IP and/or GTP header related to donor eNB 102, and forward the packet to relay eNB 104 based on the next GTP header. Relay eNB 104 can similarly remove the header(s) related to relay eNB 104, in one example, and relay eNB 104 can forward the packet to UE 110 based on the remaining IP header or another header. Though one relay eNB 104 is shown between UE 110 and donor eNB 102, it is to be appreciated that additional relay eNBs can exist, and UDP/IP and/or GTP headers can be added to uplink and downlink packets, as described, for each relay eNB to facilitate packet routing.

The additional headers, for example, can introduce overhead when transmitting packets over a radio interface (e.g., between donor eNB 102 and relay eNB 104, relay eNB 104 and relay eNB 108, etc.). Thus, for example, donor eNB 102 can compress downlink packets before transmitting to relay eNB 104, and relay eNB 104 can similarly compress downlink packets before transmitting to relay eNB 108 or UE 110. Similarly, relay eNB 104 can compress uplink packets before transmitting to donor eNB 102, and relay eNB 108 can similarly compress uplink packets. For example, packet headers related to relay eNB 104 can have static fields or data, such as a tunnel endpoint identifier (TEID) related to relay eNB 104, an IP address assigned to relay eNB 104 (e.g., by a corresponding PGW or SGW), and/or the like, that are substantially the same for all packets communicated over a related radio bearer. In addition, however, the packets can have non-static data that can change for a given packet over the radio bearer, such as a packet length, sequence number (e.g., GTP sequence number), and/or the like. In this regard, at least the static fields and/or other static data in the headers can be compressed for packets related to relay eNB 104 to mitigate sending the entire static data, which can decrease bandwidth required to forward packets thereto.

In an example, donor eNB 102 can receive a packet from core network 106 for relay eNB 104 (and/or one or more relay eNBs or devices communicating therewith). Donor eNB 102 can generate a context identifier for the packet and associate the context identifier with one or more parameters of the one or more headers (e.g., static data of the header along with location information of non-static data), a compression context or algorithm related to the packet and/or context identifier (e.g., based at least in part on a hardcoding, network specification, configuration, etc., or otherwise), and/or the like. In an example, donor eNB 102 can create the context identifier and/or associate the context identifier to a packet according to a sequence, a random sequence, a pseudo-random sequence (e.g., based at least in part on one or more parameters of the packet, a related header, or relay eNB 104), and/or the like. In addition, the context identifier can be a number of bits that can be less than a number of bits of the packet occupied by one or more parameters in one or more headers thereof. Donor eNB 102 can transmit the context identifier and the packet to relay eNB 104. In this example, relay eNB 104 can obtain the context identifier and the packet, and can associate the context identifier with one or more aspects of the packet to decompress the packet.

For example, relay eNB 104 can associate the context identifier with one or more headers of the packet, one or more parameters of the one or more headers (e.g., static data of the header along with location information of non-static data), a decompression context or algorithm related to the packet and/or context identifier (e.g., based at least in part on a hardcoding, network specification, configuration, etc., or otherwise), and/or the like. Donor eNB 102, for example, can receive one or more subsequent packets from core network 106 related to relay eNB 104. In this example, donor eNB 102 can determine that the one or more subsequent packets relate to the context identifier (e.g., the one or more subsequent packets have similar values for one or more static fields in one or more headers thereof, etc.).

Thus, donor eNB 102 can compress one or more headers of the one or more subsequent packets based at least in part on the context identifier (e.g., by using a compression context previously associated with the context identifier, etc.) and can include the context identifier within or correlated with the one or more subsequent packets, for transmission to relay eNB 104. Relay eNB 104 can then receive the one or more subsequent packets and can decompress the one or more headers based at least in part on the context identifier. In this regard, relay eNB 104 determines one or more parameters or contexts previously associated with the context identifier for decompressing the one or more headers. Similar functionality, as described herein, can be utilized to compress communications from relay eNB 104 to donor eNB 102. As described above, headers for packets communicated between donor eNB 102 and relay eNB 104 (e.g., after an initial packet for a given radio bearer) can be compressed to decrease required transmission bandwidth and improve data throughput.

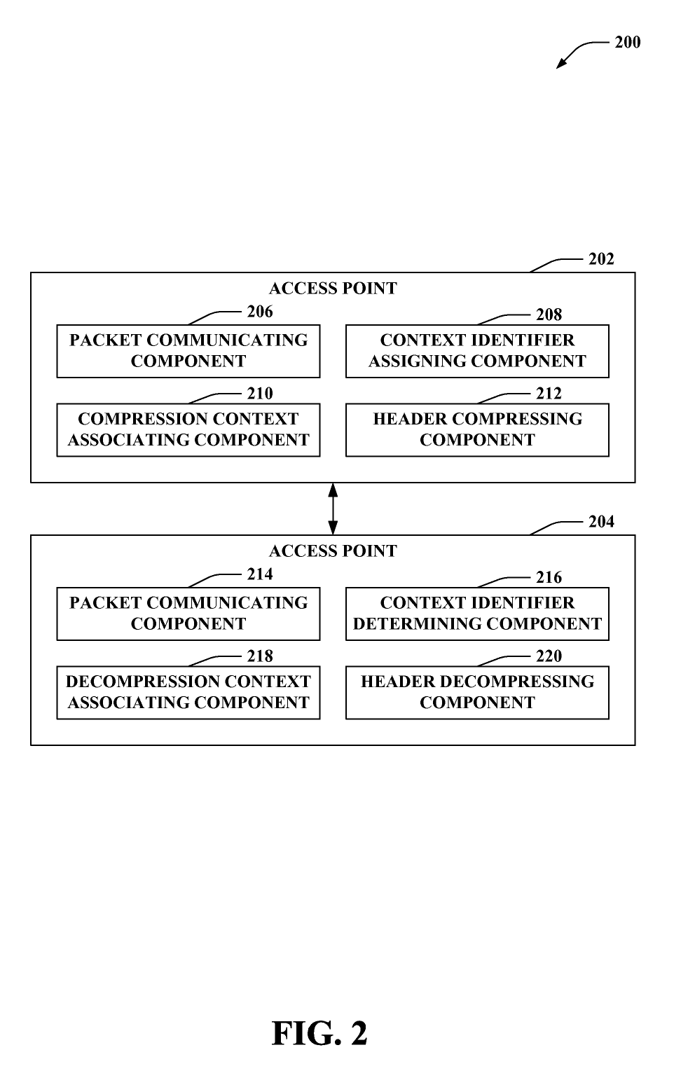

Turning now to FIG. 2, an example wireless communication system 200 that facilitates compressing packet headers for efficient communication thereof is illustrated. System 200 includes an access point 202 that communicates with another access point 204 (and/or other access points). Thus, for example, access point 202 can be a donor access point where access point 204 is a relay node, access point 204 can be a donor access point where access point 202 is a relay node, access points 202 and 204 can both be relay nodes, etc. In addition, it is to be appreciated that access point 204 can comprise the components of access point 202 to provide similar functionality, in one example, and vice versa. Moreover, access points 202 and 204 can each be a macrocell access point, femtocell access point, picocell access point, mobile base station, and/or the like, and can communicate over the air (e.g., using a E-UTRA-Uu interface, E-UTRA-Un interface, and/or the like).

Access point 202 comprises a packet communicating component 206 that receives a packet from one or more devices in a wireless network (not shown) and transmits the packet, or a compressed version thereof, to one or more access points, as well as a context identifier assigning component 208 that associates a context identifier to the packet. Access point 202 further includes a compression context associating component 210 that correlates one or more parameters related to compressing the packet or subsequent similar packets with the context identifier and a header compressing component 212 that compresses one or more subsequent packets according to the one or parameters and associates the context identifier with the one or more compressed subsequent packets.

Access point 204 comprises a packet communicating component 214 that receives a packet from an access point and transmits the packet, or a decompressed version thereof, to one or more disparate devices in a wireless network (not shown), as well as a context identifier determining component 216 that locates a context identifier associated with the packet. Access point 204 further includes a decompression context associating component 218 that generates one or more parameters for decompressing the packet or related packets and associates the one or more parameters to the context identifier, as well as a header decompressing component 220 that decompresses one or more subsequent packets based at least in part on a context identifier thereof.

According to an example, packet communicating component 206 can obtain a packet from a core network component (not shown), a mobile device (not shown), and/or the like, that relates to access point 204. Context identifier assigning component 208 can discern whether it has received or generated a context identifier for certain parameters in one or more headers of the packet (e.g., static fields or other static data in the header, such as an IP address and/or TEID related to access point 204). If context identifier assigning component 208 has not received or assigned a context identifier related to the parameters in the one or more headers, it can generate a context identifier (e.g., according to a sequence, randomly, pseudo-randomly, and/or the like, as described) for the parameters in the one or more headers. In addition, context identifier assigning component 208 can associate the context identifier to one or more parameters in the one or more headers (e.g., static data, etc.). Compression context associating component 210 can correlate the context identifier with a context or parameters for compressing the one or more headers. In one example, compression context associating component 210 can correlate the context identifier with the one or more headers as received, static and/or non-static data in the headers, location information regarding static and/or non-static data in the headers, hardcoded instructions for compressing parameters of the one or more headers, and/or the like. Packet communicating component 206 can transmit the packet and the context identifier to access point 204.

Packet communicating component 214 can obtain the packet (which is not yet compressed) and context identifier from access point 202. Context identifier determining component 216 can retrieve the context identifier (e.g., from the packet, a header thereof, an associated communication, and/or the like), and decompression context associating component 218 can correlate the context identifier with a context or one or more parameters for decompressing subsequent packets with similar data in one or more headers. For example, based at least in part on the packet received by packet communicating component 214, decompression context associating component 218 creates the context or one or more parameters for decompressing the subsequent packets. For example, creating the context or one or more parameters can include storing the one or more headers as received in the packet, storing static data and/or non-static data from the headers, location information regarding static and/or non-static data in the headers, hardcoded instructions for decompressing parameters of the one or more headers, and/or the like.

Packet communicating component 206, for example, can receive a subsequent packet related to access point 204, and context identifier assigning component 208 can associate the packet with the context identifier. In an example, context identifier assigning component 208 can interpret one or more headers of the packet to determine parameters thereof, such as an IP address, TEID, and/or other static fields or data, and can determine whether one or more stored context identifiers are associated with the parameters. In one example, context identifier assigning component 208 can cycle through one or more contexts stored by compression context associating component 210 to determine whether related static fields correspond to headers of the packet. If so, compression context associating component 210 can provide a compression context or one or more related parameters (e.g., as previously associated to the context identifier) to header compressing component 212 for compressing one or more headers of the packet according to the context identifier. Header compressing component 212 can compress the one or more headers.

In an example, header compressing component 212 can compress the one or more headers by removing a portion of static fields or data from the one or more headers (e.g., to form a concatenation of non-static data and/or remaining static data) and including the context identifier. In another example, header compressing component 212 can utilize a disparate compression algorithm to compress the static data in the one or more headers according to the context identifier (e.g., according to an algorithm determined from a hardcoding, network specification, configuration, and/or the like). In one example, such a compression algorithm can further compress non-static data in the one or more headers, such as a GTP sequence number, at least in part by including a number of least significant bits, n, where n is a positive integer less than the total number of bits comprising the sequence number. In this regard, it is to be appreciated that header compressing component 212 can leave the GTP sequence number or similar parameter uncompressed every 2⁽ⁿ⁻¹⁾ packets to prevent ambiguity caused when the sequence number wraps to the next number requiring an extra bit. Packet communicating component 206 can transmit the compressed packet to access point 204.

Packet communicating component 214, as described, can receive the compressed packet. Context identifier determining component 216 can retrieve the context identifier from the packet, and decompression context associating component 218 can select a decompression context or related parameters for decompressing the packet based at least in part on the context identifier. As described, the decompression context or related parameters can relate to those previously stored for the context identifier. Moreover, for example, the decompression context or related parameters can correspond to undoing the compression context or related parameters applied by header compressing component 212. For example, instructions and/or parameters for compressing and decompressing can be specified in a network specification related to access points 202 and 204, a configuration for the access points 202 and 204, hardcoded within the access points 202 and 204, and/or the like. Header decompressing component 220 can decompress one or more headers of the packet based at least in part on the decompression context or related parameters.

As described, for example, where the one or more headers as compressed includes a concatenation of non-static data, header decompressing component 220 can insert static fields or other static data from the one or more headers of the previously received packet within the concatenated non-static data to form the header. In another example, header decompressing component 220 can decompress the one or more headers according to another algorithm related to the context identifier and specified by a hardcoding, network specification, configuration, and/or the like. Moreover, in one example, where context identifier determining component 216 detects that the packet is compressed and decompression context associating component 218 cannot locate a decompression context related to the context identifier, decompression context associating component 218 can query access point 202 for an uncompressed version of the header, static data of the header, and/or the like.

According to an example, packet communicating component 206 can receive a packet having a format similar to the following.

| | | | | | | |
|---|---|---|---|---|---|---|
| L1 | MAC | Radio Link | PDCP | UDP/IP header (with IP | GTP header (with TEID | IP Packet |
| | | Control (RLC) | | of access point) | of access point) | |

In this regard, the UDP/IP and GTP headers can be compressed, as described, to decrease size of the packet and thus bandwidth required to communicate the packet. For example, at least the IP address of the access point 204 and the TEID of the access point 204 can be compressed as these values can be static for the given access point 204 (e.g., at least for a period of time) over a related radio bearer with access point 202. In this regard, context identifier assigning component 208 can generate a context identifier for related packets, and compression context associating component 210 can store the context identifier along with a context or parameters for compressing one or more headers of the packet (e.g., storing an IP address and TEID of access point 204). Packet communicating component 206 can transmit the packet and context identifier to access point 204.

Packet communicating component 214 can receive the communication from access point 202, and context identifier determining component 216 can retrieve the context identifier therefrom. Since the packet is uncompressed, decompression context associating component 218 can generate a decompression context or related parameters for one or more headers of the packet and store with the context identifier. For example, the decompression context or related parameters can be related to the compression context stored by compression context associating component 210, as described, to facilitate decompressing one or more headers compressed by header compressing component 212. Thus, as described in an example, the decompression context or related parameters can include static data in one or more headers of the packet (e.g., IP address and TEID of access point 204).

Packet communicating component 206 can subsequently receive a packet for access point 204 comprising a same portion of data in one or more headers as the previous packet (e.g., IP address and TEID of access point 204). Thus, context identifier assigning component 208 can determine the context identifier for the packet based at least in part on the portion of data in the one or more headers. Header compressing component 212 can compress one or more headers in the packet based on receiving a compression context or related parameters from compression context associating component 210 that correlates to the context identifier. As described, for example, the compression context can include fields to remove from the one or more headers (e.g., fields including static data), such as the IP address and TEID. Header compressing component 212 can remove such fields in this example, and include the context identifier in or along with the headers. Thus, in one example, the packet above can be compressed to a packet having a format similar to the following:

| | | | | | | |
|---|---|---|---|---|---|---|
| L1 | MAC | RLC | PDCP | CID | NSI | IP Packet |

where CID is the context identifier and NSI is non-static information (e.g., non-static data). The NSI, for example, can include values of the headers that are not removed during compression, and can be a concatenation or a structure of such values. Packet communicating component 206 can transmit the packet with the compressed header to access point 204.

Packet communicating component 214 can obtain the packet, and context identifier determining component 216 can retrieve the context identifier therefrom. Decompression context associating component 218 can determine a decompression context or one or more parameters related to the context identifier. For example, this can include the header as previously received, static data therefrom, and/or the like. Header decompressing component 220 can decompress one or more headers in the packet based at least in part on the decompression context or related parameters. In one example, header decompressing component 220 can replace non-static data (and/or a remaining portion of static data) in the header stored by decompression context associating component 218 with that received in the packet. In another example, header decompressing component 220 can decompress the one or more headers based at least in part on inserting one or more static fields stored by decompression context associating component 218 for the context identifier within non-static data (and/or a remaining portion of static data) received in the packet. In any case, packets between access points 202 and 204 can be compressed for more efficient communication thereof. In addition, it is to be appreciated that access point 202 can be upstream or downstream from access point 204, and thus the functionalities as described can be applied for downlink or uplink communications.

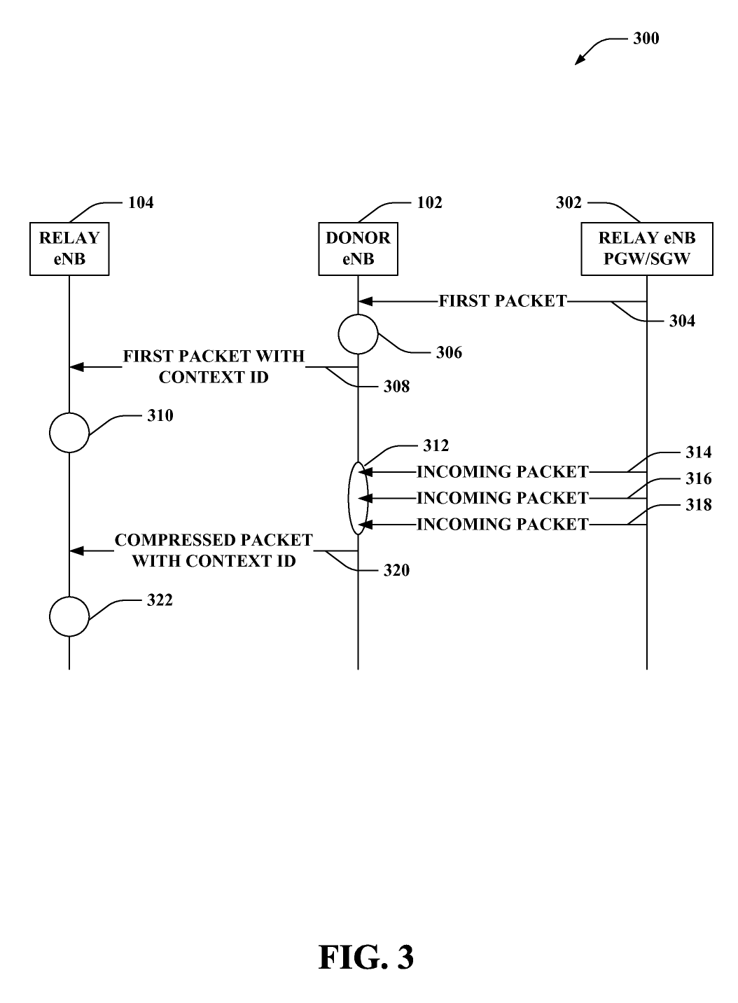

Referring to FIG. 3, an example wireless communication system 300 for compressing and decompressing headers related to routing packets among one or more relay nodes is illustrated. System 300 includes a donor eNB 102 that provides wireless network access to relay eNB 104, as described. In addition, system 300 can include a relay eNB PGW/SGW 302. As described, relay eNB PGW/SGW 302 can be part of a core network, and donor eNB 102 can provide relay eNB 104 with access to relay eNB PGW/SGW 302. In an example, relay eNB 104 can establish connection to relay eNB PGW/SGW 302 through donor eNB 102 and can receive an IP address from relay eNB PGW/SGW 302 for communicating therewith. In addition, relay eNB PGW/SGW 302 can receive or generate a TEID related to relay eNB 104 to include in packets for relay eNB 104 when providing the packets to donor eNB 102.

For example, following connection to relay eNB 104, relay eNB PGW/SGW 302 can transmit a first packet 304 to donor eNB 102 for providing to relay eNB 104. For example, donor eNB 102 can receive the first packet 304 from relay eNB PGW/SGW 302 over a wired backhaul. The first packet 304 can include a UDP/IP and GTP header related to relay eNB 104, as described. Donor eNB 102 can determine that the first packet 304 relates to relay eNB 104 (e.g., based at least in part on a TEID in a GTP header of first packet 304). In addition, donor eNB 102 can determine whether a context identifier has been generated relating to one or more parameters of one or more headers of first packet 304 (e.g., an IP address or TEID of relay eNB 104, as related to a radio bearer with donor eNB 102 or otherwise). In this case, since it is the first packet, a context identifier has not been associated to the one or more parameters.

Donor eNB 102 can associate a context identifier and a compression context (or related parameters) to the one or more parameters of the one or more headers at 306, as described. In one example, the compression context (or related parameters) can relate to instructions for compressing fields of the one or more headers (e.g., according to a specification, configuration, hardcoding, etc.). Donor eNB 102 can transmit the first packet with the context identifier 308 to relay eNB 104. Relay eNB 104 can detect the uncompressed packet and can generate a decompression context or related parameters for subsequent packets having similar header parameters of the uncompressed packet at 310. Relay eNB 104 can additionally associate the context identifier with the decompression context or related parameters, as described, at 310.

Subsequently to receiving first packet 304, as described, donor eNB 102 can obtain other incoming packets 314, 316, and 318 from relay eNB PGW/SGW 302. At 312, donor eNB 102 can determine whether it has generated context identifiers related to parameters in the headers of incoming packets 314, 316, and 318. In this example, donor eNB 102 determines that it has stored a context identifier for at least one incoming packet 314, 316, or 318. For example, the incoming packet can be incoming packet 316, and at 312, donor eNB 102 compares one or more parameters in one or more headers of packet 316 to parameters related to one or more context identifier. At 312, donor eNB 102 discerns that the parameters in the one or more headers of incoming packet 316 match those for a context identifier. Donor eNB can compress the one or more headers of incoming packet 316 according to a compression context (or related parameters), as described, and can transmit the compressed packet with context identifier 320 to relay eNB 104. Relay eNB 104 can decompress the packet according to the context identifier at 322, as it relates to a decompression context (or related parameters), as described above.

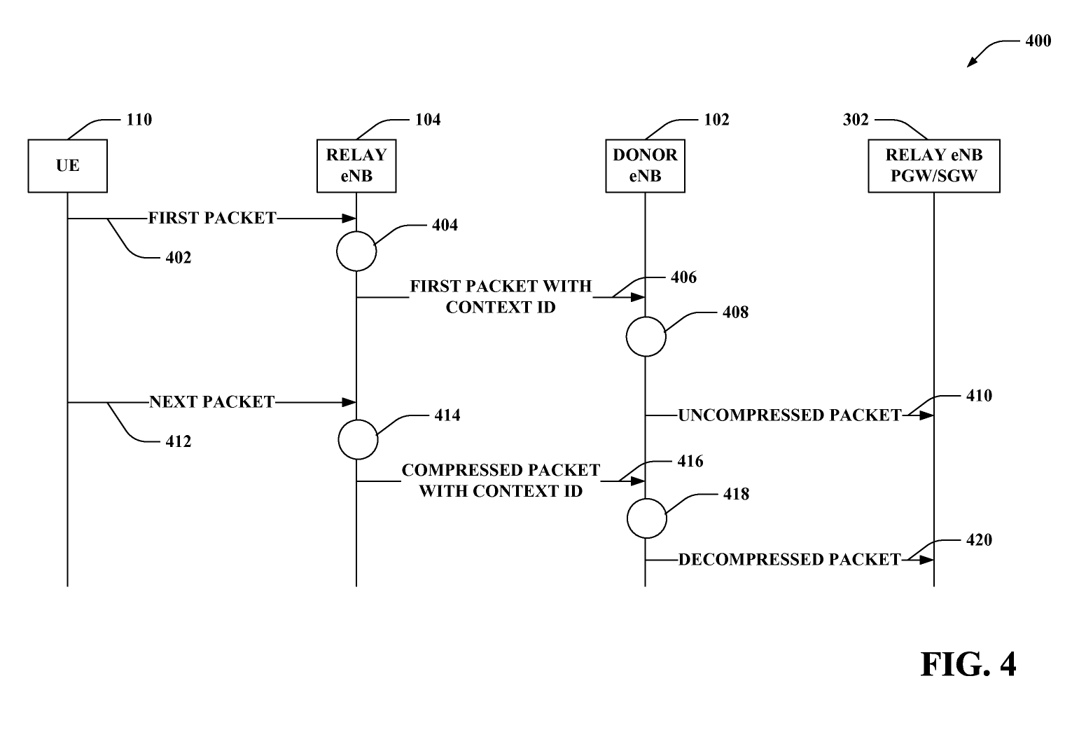

Referring to FIG. 4, an example wireless communication system 400 for compressing and decompressing headers related to routing packets among one or more relay nodes is illustrated. System 400 includes a donor eNB 102 that provides wireless network access to relay eNB 104, as described, and a UE 110 that receives wireless network access from relay eNB 104. In addition, system 400 can include a relay eNB PGW/SGW 402. As described, relay eNB PGW/SGW 402 can be part of a core network, and donor eNB 102 can provide relay eNB 104 with access to relay eNB PGW/SGW 402. In an example, relay eNB 104 can establish connection to relay eNB PGW/SGW 402 through donor eNB 102 and can receive an IP address for communicating with relay eNB PGW/SGW 402. In addition, relay eNB PGW/SGW 402 can receive or generate a TEID related to relay eNB 104 to include in packets for relay eNB 104 when providing the packets to donor eNB 102.

For example, UE 110 can connect to relay eNB 104 and transmit a first packet 402 thereto. At 404, relay eNB 104 can generate a context identifier and an associated compression context (or related parameters) for compressing headers of subsequent packets having similar parameters, as described. Relay eNB 104 can transmit the first packet with context identifier 406 to donor eNB 102. Donor eNB 102 can generate a decompression context (or related parameters) for decompressing packets compressed according to the compression context (or related parameters), as described, at 408. Donor eNB 102 can additionally associate the decompression context (or related parameters) with the context identifier, as described above. Donor eNB 102 can transmit the uncompressed packet 410 to relay eNB PGW/SGW 302.

Relay eNB 104 can receive a next packet 412 from UE 110. Relay eNB 104 can determine that it has generated a context identifier for packets having similar header parameters as next packet 412 and can compress at least a portion of the one or more headers of next packet 412 (e.g., according to the compression context (or related parameters) described above) at 414. Relay eNB 104 can transmit the compressed packet with context identifier 416 to donor eNB 102. Donor eNB 102 can determine the packet is compressed and can retrieve the context identifier at 418. Donor eNB 102 can further determine the corresponding decompression context (or related parameters) based on the context identifier and can decompress the packet at 418. Donor eNB 102 can transmit the decompressed packet 420 to relay eNB PGW/SGW 302.

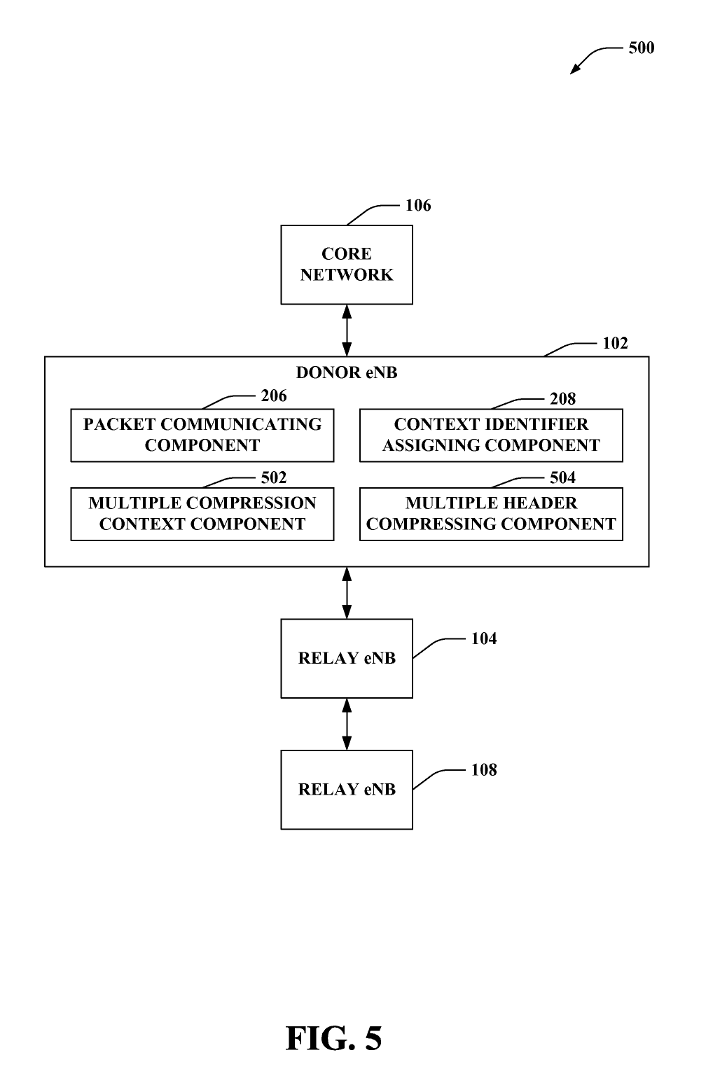

Turning now to FIG. 5, an example wireless communication system 500 that facilitates compressing downlink packet headers for multiple relay eNBs is illustrated. System 500 includes a donor eNB 102 that provides relay eNB 104 (and/or other relay eNBs) with access to core network 106. Additionally, as described, relay eNB 104 can provide one or more devices, such as a UE, and/or other relay eNBs, such as relay eNB 108, with access to the core network 106 through the donor eNB 102. Moreover, donor eNB 102 can be a macrocell access point, femtocell access point, picocell access point, mobile base station, and/or the like. Relay eNBs 104 and 108 can similarly each be a mobile or stationary relay node that communicates with donor eNB 102 over a wireless or wired backhaul, as described.

Donor eNB 102 comprises a packet communicating component 206 that receives a packet from core network 106 and transmits the packet, or a compressed version thereof, to one or more relay eNBs, as well as a context identifier assigning component 208 that associates a context identifier to the packet. Donor eNB 102 further includes a multiple compression context component 502 that associates one or more parameters related to compressing headers of the packet or subsequent similar packets corresponding to a plurality of relay eNBs with the context identifier and a multiple header compressing component 504 that compresses the headers of the packet or subsequent similar packets according to the one or parameters and associates the context identifier with the one or more compressed subsequent packets.

According to an example, core network 106 can transmit a packet for relay eNB 108 to donor eNB 102. Packet communicating component 206 can receive the packet, as described, and context identifier assigning component 208 can determine whether a context identifier has been assigned to one or more parameters of one or more headers in the packet. The packet, for example, can have headers related to relay eNB 104 and relay eNB 108 (e.g., to facilitate routing the packet to relay eNB 108 through relay eNB 104). In this regard, context identifier assigning component 208 can retrieve parameters from headers related to each of the relay eNBs 104 and 108 (e.g., IP address and TEID of each), and can determine whether a context identifier is assigned to the combination of parameters. If not, as described, context identifier assigning component 208 can select a context identifier for the combination of parameters.

In addition, in this example, multiple compression context component 502 can define compression contexts (and/or related parameters) for compressing the headers related to relay eNB 104 and relay eNB 108, and can associate such with the context identifier. In one example, the compression contexts can relate to removing certain static data from the headers and transmitting remaining data (e.g., non-static data and/or a remaining portion of static data) in the headers with an indication of the context identifier, for example. In another example, the compression contexts can relate to defined instructions for compressing at least a portion of the headers according to an algorithm. In either case, packet communicating component 206 can transmit the uncompressed packet and context identifier to relay eNB 104. Relay eNB 104 can store the context identifier along with a defined context (or related parameters) for decompressing subsequent packets, as described. Moreover, as described above, the decompression context and/or related parameters can correlate to the compression context or related parameters to facilitate decompressing headers compressed by multiple header compressing component 504.

Relay eNB 104 can further transmit the uncompressed packet and context identifier to relay eNB 108. Relay eNB 108 can similarly store the context identifier along with a defined context (or related parameters) for decompressing subsequent packets, as described. Packet communicating component 206 can subsequently receive another packet for relay eNB 108 that includes similar parameters in the headers as the previously received packet (e.g., at least some static data, such as IP addresses and TEIDs of relay eNBs 104 and 108). Context identifier assigning component 208 can determine that it has a context identifier related to the similar parameters, and multiple header compressing component 504 can compress the headers of the packet according to a compression context (or related parameters), stored in the multiple compression context component 502, that corresponds to the context identifier (described above). Thus, in one example, the compression context can relate to removing static data from the headers or utilizing a predefined compression algorithm. In either case, packet communicating component 206 can transmit the compressed packet and context identifier to relay eNB 104.

As described above, relay eNB 104 can decompress its headers (e.g., outermost headers of the packet) based at least in part on utilizing a decompression context (or related parameters) determined based on the context identifier. For example, the decompression context can be related to inserting received non-static data within static data related to the context identifier, utilizing a predefined decompression algorithm related to the context identifier, and/or the like. Relay eNB 104 can transmit the compressed packet and context identifier to relay eNB 108, which can similarly decompress the packet (or at least its headers) utilizing a decompression context (or related parameters) corresponding to the context identifier. In one example, it is to be appreciated that relay eNB 104 can forward the compressed packet to relay eNB 108 based on the context identifier without first decompressing the packet.

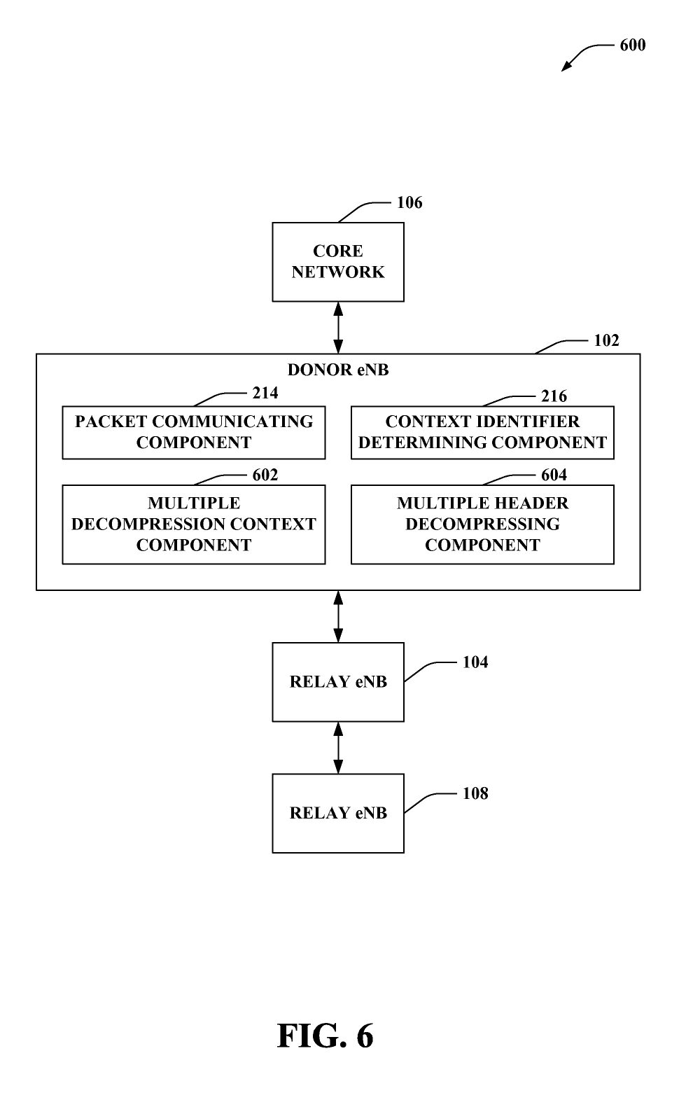

Turning now to FIG. 6, an example wireless communication system 600 that facilitates compressing uplink packet headers for multiple relay eNBs is illustrated. System 600 includes a donor eNB 102 that provides relay eNB 104 (and/or other relay eNBs) with access to core network 106. Additionally, as described, relay eNB 104 can provide one or more devices, such as a UE, and/or other relay eNBs, such as relay eNB 108, with access to the core network 106 through the donor eNB 102. Moreover, donor eNB 102 can be a macrocell access point, femtocell access point, picocell access point, mobile base station, and/or the like. Relay eNBs 104 and 108 can similarly each be a mobile or stationary relay node that communicates with donor eNB 102 over a wireless or wired backhaul, as described.

Donor eNB 102 comprises a packet communicating component 214 that receives a packet from relay eNB 104 and transmits the packet, or a compressed version thereof, to core network 106, as well as a context identifier determining component 216 that obtains a context identifier for the packet. Donor eNB 102 further includes a multiple decompression context component 602 that associates one or more parameters related to decompressing headers of the packet or subsequent similar packets corresponding to a plurality of relay eNBs with the context identifier and a multiple header decompressing component 604 that decompresses the headers of the packet or subsequent similar packets according to the one or parameters.

According to an example, relay eNB 108 can generate or receive a packet (e.g., from a UE) for transmitting to core network 106. Relay eNB 108 can associate a context identifier with the packet, as described, and can create a compression context (or related parameters) for compressing headers of the packet associated with relay eNB 108. Relay eNB 108 can transmit the packet and context identifier to relay eNB 104. Relay eNB 104 can similarly define a compression context (or related parameters) for compressing headers of the packet related to relay eNB 104, and can associate the context identifier to the packet. It is to be appreciated, for example, the relay eNB 104 and/or 108 can include procedures for resolving conflicts with context identifiers (e.g. where relay eNB 104 assigns a context identifier and receives the same context identifier for disparate header parameters from relay eNB 108). Relay eNB 104 can transmit the packet and the context identifier to donor eNB 102.

In this example, packet communicating component 214 can receive the packet along with the context identifier. Context identifier determining component 216, for example, retrieves the context identifier, and multiple decompression context component 602 can generate decompression contexts (or related parameters) for the headers in the packet the separately relate to relay eNB 104 and 108. Thus, for example, multiple decompression context component 602 can create disparate contexts (or related parameter) for decompressing headers related to a given relay eNB corresponding to the context identifier.

Relay eNB 108 can then generate or receive a next packet that has similar parameters in its headers as the previous packet. Relay eNB 108 can determine the similar parameters and corresponding context identifier and can compress headers related to relay eNB 108 using the compression context (or related parameters) related to the context identifier. Relay eNB 108 can transmit the packet to relay eNB 104, which can similarly compress headers related to relay eNB 104 based at least in part on the context identifier. Relay eNB 104 can transmit the compressed packet and the context identifier to donor eNB 102.

Packet communicating component 214 can obtain the packet, and context identifier determining component 216 can extract the context identifier. Since the headers are compressed, multiple decompression context component 602 can obtain decompression contexts related to the various headers of the packet based at least in part on the context identifier. For example, multiple decompression context component 602 can obtain decompression contexts related to relay eNB 104 and relay eNB 108. Multiple header decompressing component 604 can decompress the headers based at least in part on the decompression contexts, as described. For example, multiple header decompressing component 604 can apply a decompression context related to relay eNB 108 based on the context identifier to the outermost headers relating to relay eNB 108, and then apply a disparate compression context related to relay eNB 104 based on the context identifier to the next outer most headers relating to relay eNB 104. It is to be appreciated that where additional relay eNBs exist between relay eNB 104 and donor eNB 102, multiple decompression context component 602 can have generated additional decompression contexts upon receiving the initial packet, and multiple header decompressing component 604 can continue applying contexts to decompress subsequent packets until no headers remain compressed.

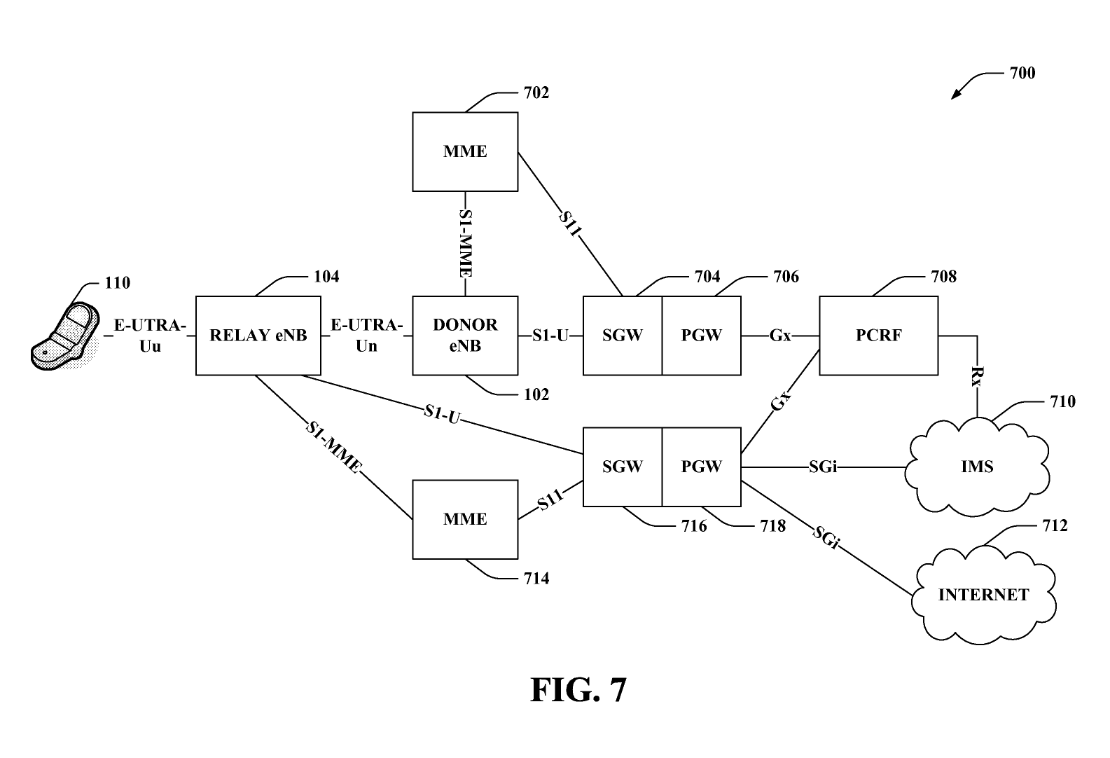

Now turning to FIG. 7, an example wireless communication network 700 that provides IP relay functionality is depicted. Network 700 includes a UE 110 that communicates with a relay eNB 104, as described, to receive access to a wireless network. Relay eNB 104 can communicate with a donor eNB 102 to provide access to a wireless network, and as described, donor eNB 102 can communicate with an MME 702 and/or SGW 704 that relate to the relay eNB 104. SGW 704 can connect to or be coupled with a PGW 706, which provides network access to SGW 704 and/or additional SGWs. PGW 706 can communicate with a policy and charging rules function (PCRF) 708 to authenticate/authorize relay eNB 104 to use the network, which can utilize an IP multimedia subsystem (IMS) 710 to provide addressing to the relay eNB 104.

According to an example, SGW 704 and PGW 706 can also communicate with SGW 716 and PGW 718, which can be related to UE 110. For example, SGW 716 and/or PGW 718 can assign an IP address to UE 110 and can communicate therewith via SGW 704 and PGW 706, donor eNB 102, and relay eNB 104. Communications between UE 110 and SGW 716 and/or PGW 718 can be tunneled through the nodes. SGW 704 and PGW 706 can similarly tunnel communications between UE 110 and MME 714. PGW 718 can similarly communicate with a PCRF 708 to authenticate/authorize UE 110, which can communicate with an IMS 710. In addition, PGW 718 can communicate directly with the IMS 710 and/or internet 712.

In an example, UE 110 can communicate with the relay eNB 104 over one or more radio protocol interfaces, such as an E-UTRA-Uu interface, as described, and the relay eNB 104 can communicate with the donor eNB 102 using one or more radio protocol interfaces, such as an E-UTRA-Un or other interface. As described, relay eNB 104 can add a UDP/IP and/or GTP header related to SGW 704 and/or PGW 706 to packets received from UE 110. Moreover, relay eNB 104 can compress the UDP/IP and GTP headers, as described herein, and can forward the packets to donor eNB 102 along with a context identifier. Donor eNB 102 communicates with the MME 702 using an S1-MME interface and the SGW 704 and PGW 706 over an S1-U interface, as depicted. For example, donor eNB 102 can decompress the packets according to the context identifier (e.g., where the identifier is associated with a decompression context, as described) and can similarly add an UDP/IP and/or GTP header to the packets and forward to MME 702 or SGW 704.

SGW 704 and/or PGW 706 can utilize the UDP/IP and/or GTP headers to route the packets within the core network. For example, as described, SGW 704 and/or PGW 706 can receive the packets and remove the outer UDP/IP and/or GTP header, which relates to the SGW 704 and/or PGW 706. SGW 704 and/or PGW 706 can process the next UDP/IP and/or GTP header to determine a next node to receive the packets, which can be SGW 716 and/or PGW 718, which relate to UE 110. Similarly, SGW 716 and/or PGW 718 can obtain downlink packets related to UE and can include an UDP/IP header and/or GTP header related to communicating the packets to relay eNB 104 for providing to UE 110. SGW 716 and/or PGW 718 can forward the packets to SGW 704 and/or PGW 706, which relate to relay eNB 104. SGW 704 and/or PGW 706 can further include an additional UDP/IP and/or GTP header in the packets related to donor eNB 102.

SGW 704 and/or PGW 706 can communicate the packets to donor eNB 102 over a tunnel (e.g., by including one or more parameters in the GTP header included by SGW 704 and/or PGW 706). Donor eNB 102 can remove the outer GTP and/or UDP/IP header included by SGW 704 and/or PGW 706 and can determine a next node to receive the packets. Donor eNB 102 can compress the packets according to a stored compression context, as described, and can transmit the packets with a related context identifier to relay eNB 104 over a radio bearer related to a GTP tunnel. Relay eNB 104 can receive the packets and can decompress the headers according to a decompression context previously associated with the context identifier, as described. Relay eNB 104 can also determine a next node to receive the packets and/or a bearer over which to transmit the packets based at least in part on one or more parameters in the next UDP/IP or GTP header, the radio bearer over which the packets are received, etc. Relay eNB 104 can remove the UDP/IP and GTP headers related to relay eNB 104, compress remaining headers, in one example, and transmit the packets to UE 110. UE 110, as described, can decompress compressed headers at a PDCP layer for processing thereof by an upper communication layer.

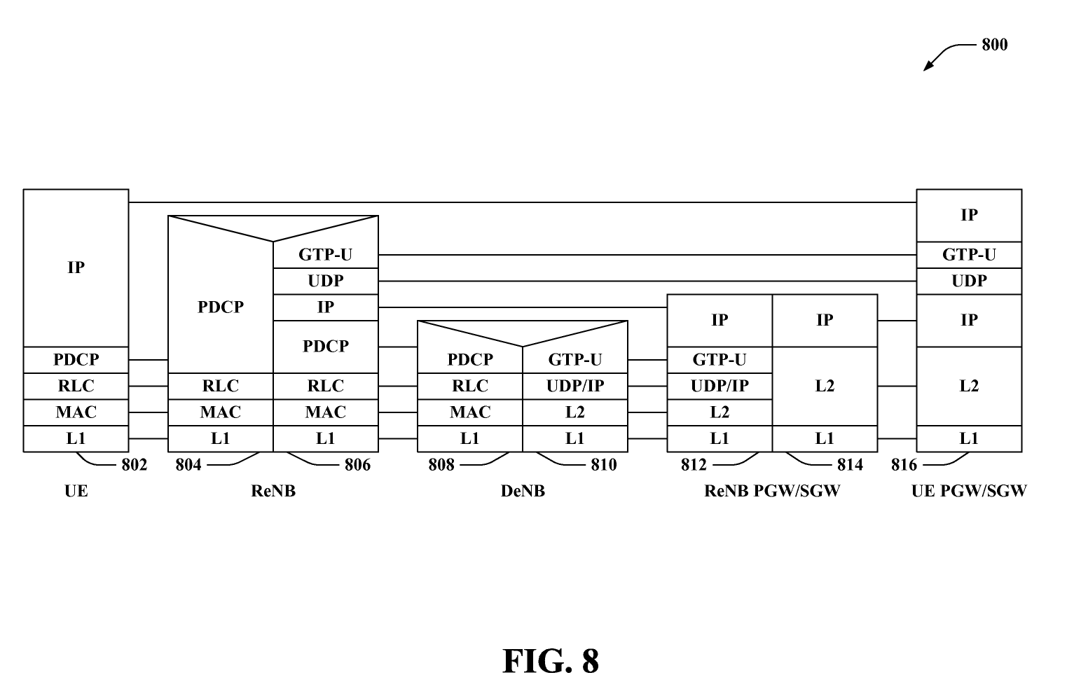

Referring to FIG. 8, example protocol stacks 800 are illustrated that facilitate communicating in a wireless network to provide relay functionality. A UE protocol stack 802 is shown comprising an L1 layer, MAC layer, an RLC layer, a PDCP layer, and an IP layer. A relay eNB (ReNB) access link protocol stack 804 is depicted having an L1 layer, MAC layer, RLC layer, and PDCP layer, along with an ReNB backhaul link protocol stack 806 having an L1 layer, MAC layer, RLC layer, PDCP layer, IP layer, UDP layer, and GTP-U layer. A donor eNB (DeNB) access link protocol stack 808 is also shown having an L1 layer, MAC layer, RLC layer, and a PDCP layer, along with a DeNB backhaul link protocol stack 810 having an L1 layer, L2 layer, a UDP/IP layer, and a GTP-U. In addition, an ReNB PGW/SGW access link protocol stack 812 is shown having an L1 layer, L2 layer, UDP/IP layer, GTP-U layer, and IP layer, as well as a ReNB PGW/SGW backhaul link protocol stack 814 including an L1 layer, L2 layer, and IP layer. Moreover, a UE PGW/SGW protocol stack 816 is depicted having an L1 layer, L2, layer, IP layer related to ReNB PGW/SGW, UDP layer, GTP-U layer, and an IP layer related to a UE.

According to an uplink communication example, a UE can communicate with an ReNB for IP communications to a UE PGW/SGW. In this regard, UE can communicate over L1, MAC, RLC, and PDCP layers with the ReNB (e.g., using a EUTRA-Uu interface), as shown between protocol stacks 802 and 804. The UE can tunnel IP layer communications through the ReNB and other entities to the UE PGW/SGW, which assigns an IP address to the UE, as shown between protocol stacks 802 and 816. To facilitate such tunneling, the ReNB can insert an IP header to communicate access link packets to an ReNB PGW/SGW through one or more other nodes on the backhaul link, as shown between protocol stacks 806 and 812. In addition, ReNB inserts GTP-U and UDP headers related to the UE PGW/SGW, as shown between protocol stacks 806 and 816, to facilitate the tunneling.

Moreover, ReNB and can communicate with a DeNB over L1, MAC, RLC, and PDCP layers (e.g., using an EUTRA-Un interface), as shown between protocol stacks 806 and 808. The DeNB can remove the PDCP, RLC, and MAC layers, which facilitate air communications, and can subsequently communicate with ReNB PGW/SGW over L1, L2, UDP/IP, and GTP-U layers, as shown between protocol stacks 810 and 812. In this regard, DeNB can add the GTP-U and UDP/IP layers related to ReNB the PGW/SGW to tunnel the GTP-U, UDP, and IP layers of the ReNB to the ReNB PGW/SGW. ReNB PGW/SGW can remove the GTP-U and UDP/IP layers, and can subsequently communicate with UE PGW/SGW over L1, L2, and IP layers to tunnel IP communications from UE, as described. Thus, as described, IP and/or GTP headers between the ReNB and DeNB can be compressed and decompressed according to a context identifier communicated to the DeNB by the ReNB. It is to be appreciated that similar procedures can be utilized to tunnel downlink packets from the UE PGW/SGW to the UE.

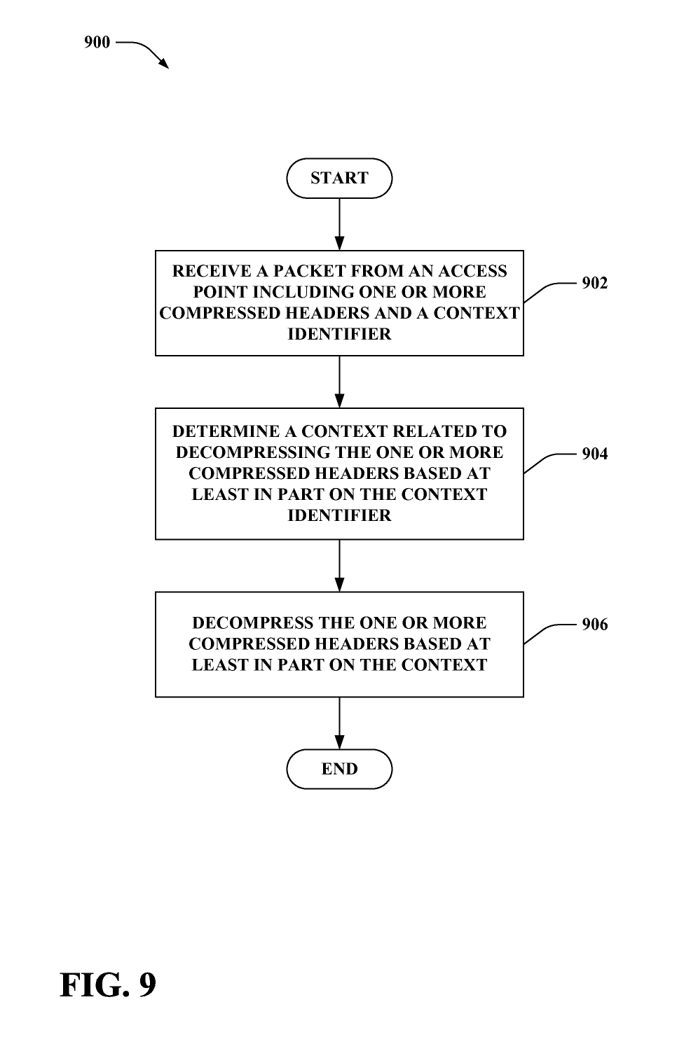

Referring to FIGS. 9-12, methodologies relating to compressing packet headers for relay communication are illustrated. While, for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Turning to FIG. 9, an example methodology 900 that facilitates decompressing headers of a received packet according to a related context is illustrated. At 902, a packet can be received from an access point including one or more compressed headers and a context identifier. As described, for example, the context identifier can be previously received along with a disparate packet, and a decompression context can be generated for the disparate packet and associated with the context identifier. Thus, at 904, a context related to decompressing the one or more compressed headers can be determined based at least in part on the context identifier. This can be the previously generated context. Moreover, as described, the context can include an algorithm for decompressing packet headers as indicated in a network specification, configuration, hardcoding, etc. In another example the context can include one or more parameters regarding decompressing packet headers, such as one or more headers of the previous packet and location information for non-static data, static fields of the one or more headers of the previous packet, and/or the like. At 906, the one or more compressed headers can be decompressed based at least in part on the context.

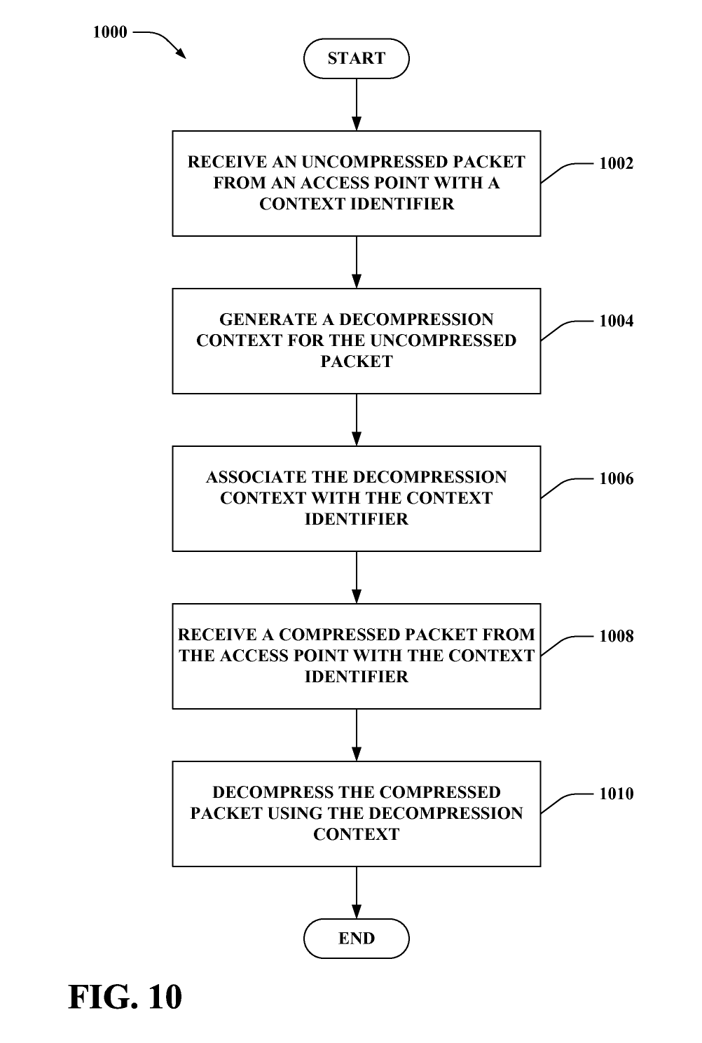

Referring to FIG. 10, an example methodology 1000 is depicted that facilitates generating a decompression context for decompressing packet headers. At 1002, an uncompressed packet can be received from an access point with a context identifier. The uncompressed packet, as described, can include one or more headers having static fields that can be compressed for the access point. Thus, at 1004, a decompression context can be generated for the uncompressed packet. As described, this can relate to performing a decompression algorithm indicated in a network specification, configuration, hardcoding, etc. Moreover, in an example, the decompression context can include one or more parameters related to inserting the static fields in received non-static data, populating non-static fields of headers received in the uncompressed packet with non-static data received in subsequent packets, and/or the like, as described. At 1006, the decompression context can be associated with the context identifier. In this regard, the decompression context can be used to decompress subsequent packets that indicate the context identifier. At 1008, a compressed packet can be received from the access point with the context identifier, and at 1010, the compressed packet can be decompressed using the decompression context. Thus, for example, based on the context identifier, the decompression context can be obtained and utilized to decompress the compressed packet, as described herein.

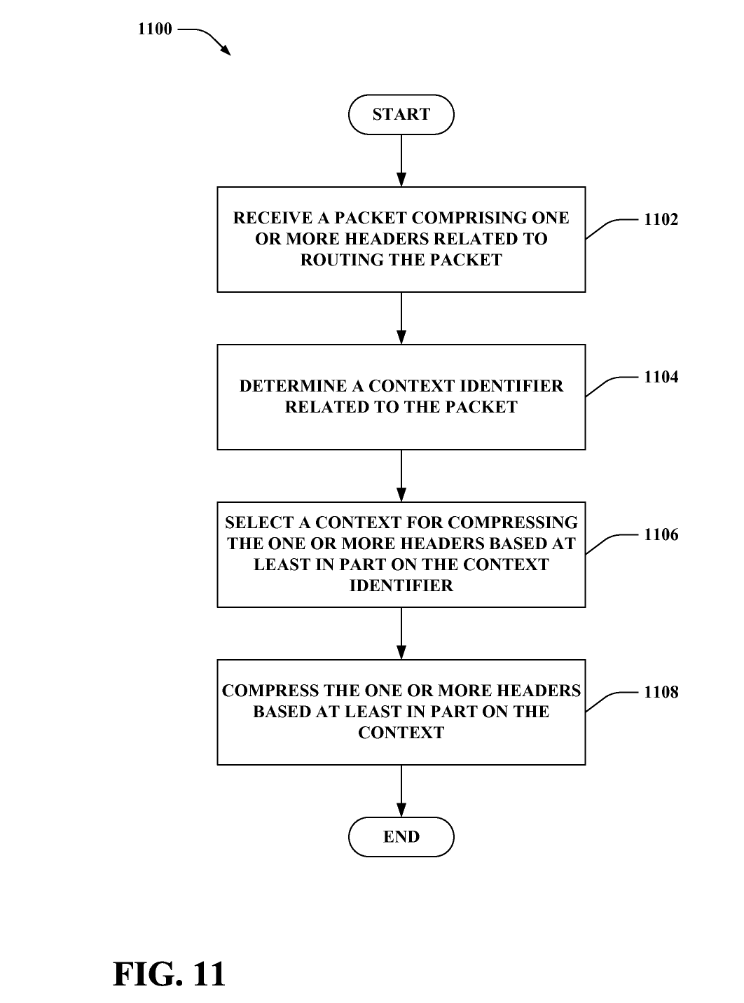

Turning to FIG. 11, an example methodology 1100 that facilitates compressing headers of a received packet is illustrated. At 1102, a packet comprising one or more headers related to routing the packet can be received. As described, for example, the headers can include static fields (e.g., IP address, TEID, etc. in UDP/IP and GTP headers) and non-static fields (e.g., GTP sequence number, packet length, etc.). At 1104, a context identifier related to the packet can be determined. In an example, as described, this can include determining a previously stored context identifier that corresponds to a portion of the one or more headers (e.g., static fields thereof). At 1106, a context for compressing the one or more headers can be selected based at least in part on the context identifier. The context, for example, can have been previously generated with the context identifier for an initial packet from an access point, as described, to facilitate compressing subsequent packets from the access point, for example. At 1108, the one or more headers can be compressed based at least in part on the context. As described, the context can include a compression algorithm from a network specification, configuration, hardcoding, etc., instructions related to removing static fields from the one or more headers, and/or the like.

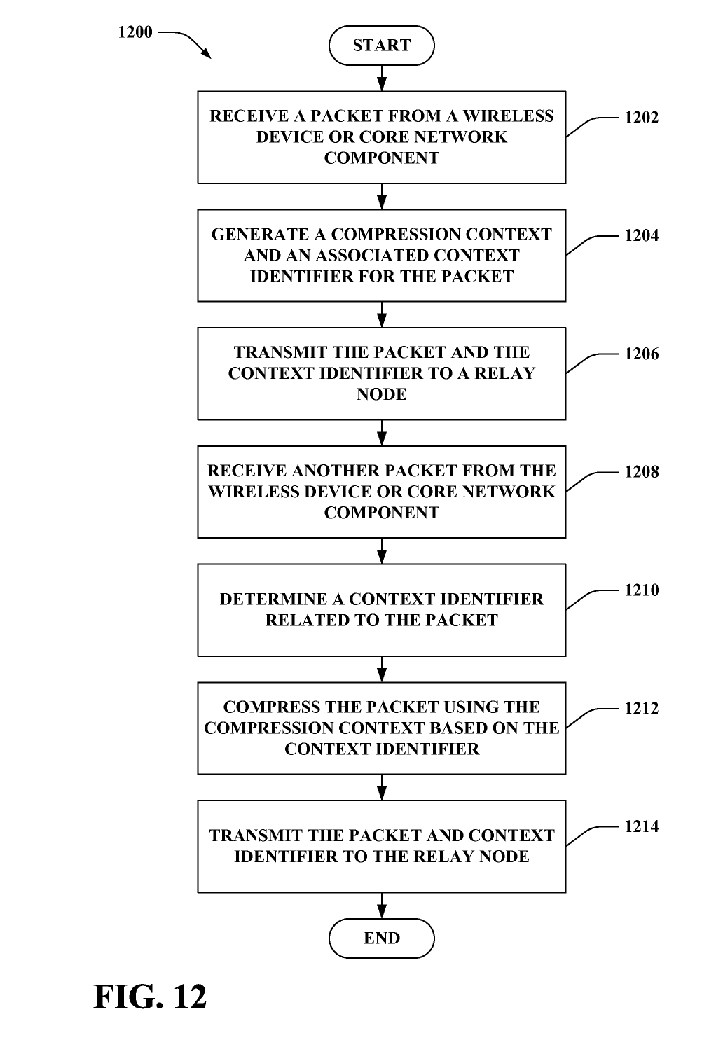

Referring to FIG. 12, an example methodology 1200 that facilitates compressing one or more packets and providing a context identifier for decompressing the one or more packets is illustrated. At 1202, a packet can be received from a wireless device or core network component. As described, for example, the packet can include static fields in one or more headers that can be compressed for communicating the packet among one or more relay nodes. At 1204, a compression context and an associated context identifier can be generated for the packet. This can include, for example, initializing a compression algorithm according to a network specification, configuration, hardcoding, and/or the like in the context. In another example, this can include initializing one or more parameters for removing static fields from the headers, etc., as described.

At 1206, the packet and the context identifier can be transmitted to a relay node. In this regard, as described, the relay node can generate a corresponding decompression context and correlate it to the context identifier. At 1208, another packet can be received from the wireless device or core network component. At 1210, a context identifier related to the packet can be determined. Thus, as described for example, the context identifier can be located for the packet based at least in part on evaluating at least a portion of the one or more headers (e.g., one or more static fields in the headers). At 1212, the packet can be compressed using the compression context, based on the context identifier. At 1214, the packet and context identifier can be transmitted to the relay node. Thus, as described, the relay node can utilize the context identifier to determine a decompression context to decompress the packet.

It will be appreciated that, in accordance with one or more aspects described herein, inferences can be made regarding generating a compression or decompression context, selecting a context identifier, and/or other aspects described herein. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

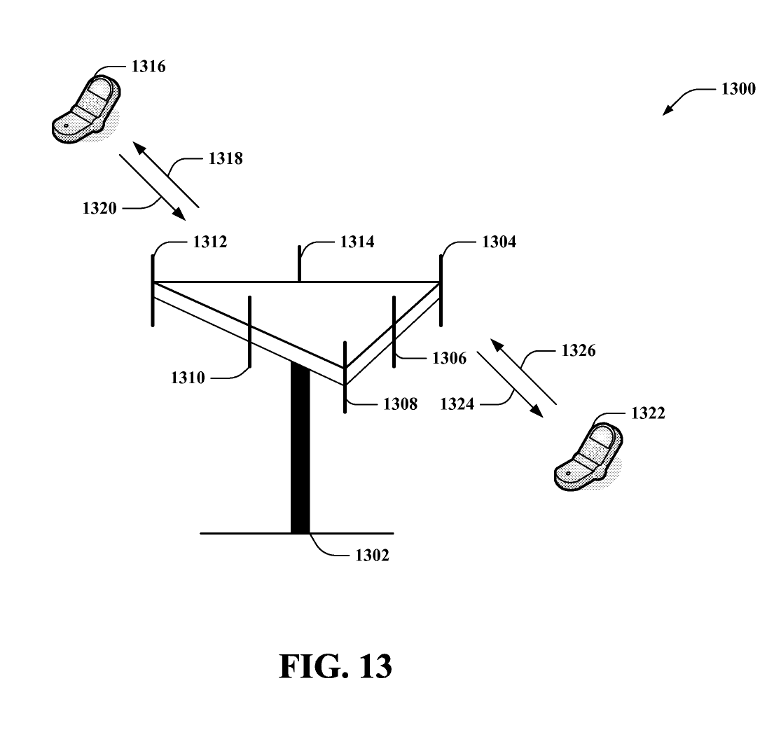

Referring now to FIG. 13, a wireless communication system 1300 is illustrated in accordance with various embodiments presented herein. System 1300 comprises a base station 1302 that can include multiple antenna groups. For example, one antenna group can include antennas 1304 and 1306, another group can comprise antennas 1308 and 1310, and an additional group can include antennas 1312 and 1314. Two antennas are illustrated for each antenna group; however, more or fewer antennas can be utilized for each group. Base station 1302 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 1302 can communicate with one or more mobile devices such as mobile device 1316 and mobile device 1322; however, it is to be appreciated that base station 1302 can communicate with substantially any number of mobile devices similar to mobile devices 1316 and 1322. Mobile devices 1316 and 1322 can be, for example, cellular phones, smart phones, laptops, handheld communication devices, handheld computing devices, satellite radios, global positioning systems, PDAs, and/or any other suitable device for communicating over wireless communication system 1300. As depicted, mobile device 1316 is in communication with antennas 1312 and 1314, where antennas 1312 and 1314 transmit information to mobile device 1316 over a forward link 1318 and receive information from mobile device 1316 over a reverse link 1320. Moreover, mobile device 1322 is in communication with antennas 1304 and 1306, where antennas 1304 and 1306 transmit information to mobile device 1322 over a forward link 1324 and receive information from mobile device 1322 over a reverse link 1326. In a frequency division duplex (FDD) system, forward link 1318 can utilize a different frequency band than that used by reverse link 1320, and forward link 1324 can employ a different frequency band than that employed by reverse link 1326, for example. Further, in a time division duplex (TDD) system, forward link 1318 and reverse link 1320 can utilize a common frequency band and forward link 1324 and reverse link 1326 can utilize a common frequency band.

Each group of antennas and/or the area in which they are designated to communicate can be referred to as a sector of base station 1302. For example, antenna groups can be designed to communicate to mobile devices in a sector of the areas covered by base station 1302. In communication over forward links 1318 and 1324, the transmitting antennas of base station 1302 can utilize beamforming to improve signal-to-noise ratio of forward links 1318 and 1324 for mobile devices 1316 and 1322. Also, while base station 1302 utilizes beamforming to transmit to mobile devices 1316 and 1322 scattered randomly through an associated coverage, mobile devices in neighboring cells can be subject to less interference as compared to a base station transmitting through a single antenna to all its mobile devices. Moreover, mobile devices 1316 and 1322 can communicate directly with one another using a peer-to-peer or ad hoc technology (not shown).

According to an example, system 1300 can be a multiple-input multiple-output (MIMO) communication system. Further, system 1300 can utilize substantially any type of duplexing technique to divide communication channels (e.g., forward link, reverse link, . . . ) such as FDD, FDM, TDD, TDM, CDM, and the like. In addition, communication channels can be orthogonalized to allow simultaneous communication with multiple devices over the channels; in one example, OFDM can be utilized in this regard. Thus, the channels can be divided into portions of frequency over a period of time. In addition, frames can be defined as the portions of frequency over a collection of time periods; thus, for example, a frame can comprise a number of OFDM symbols. The base station 1302 can communicate to the mobile devices 1316 and 1322 over the channels, which can be create for various types of data. For example, channels can be created for communicating various types of general communication data, control data (e.g., quality information for other channels, acknowledgement indicators for data received over channels, interference information, reference signals, etc.), and/or the like.

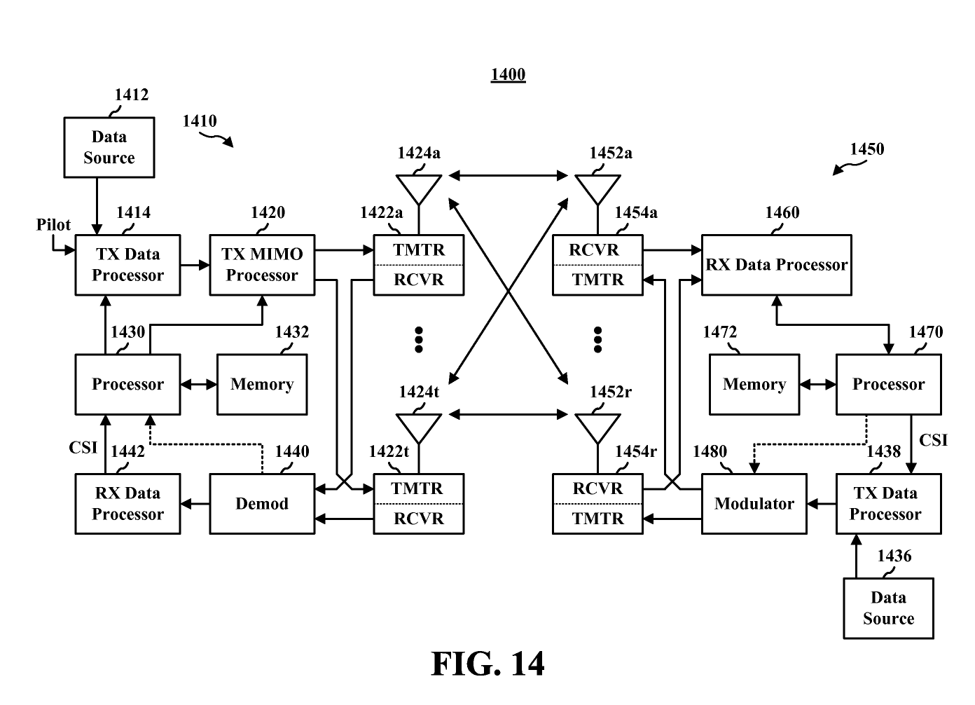

FIG. 14 shows an example wireless communication system 1400. The wireless communication system 1400 depicts one base station 1410 and one mobile device 1450 for sake of brevity. However, it is to be appreciated that system 1400 can include more than one base station and/or more than one mobile device, wherein additional base stations and/or mobile devices can be substantially similar or different from example base station 1410 and mobile device 1450 described below. In addition, it is to be appreciated that base station 1410 and/or mobile device 1450 can employ the systems (FIGS. 1-7 and 13), protocol stacks (FIG. 8) and/or methods (FIGS. 9-12) described herein to facilitate wireless communication therebetween.

At base station 1410, traffic data for a number of data streams is provided from a data source 1412 to a transmit (TX) data processor 1414. According to an example, each data stream can be transmitted over a respective antenna. TX data processor 1414 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1450 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1430.

The modulation symbols for the data streams can be provided to a TX MIMO processor 1420, which can further process the modulation symbols (e.g., for OFDM). TX MIMO processor 1420 then provides N_{T} modulation symbol streams to N_{T} transmitters (TMTR) 1422a through 1422t. In various aspects, TX MIMO processor 1420 applies beamforming weights to the symbols of the data streams and to the antenna from which the symbol is being transmitted.

Each transmitter 1422 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1422a through 1422t are transmitted from N_{T} antennas 1424a through 1424t, respectively.

At mobile device 1450, the transmitted modulated signals are received by N_{R} antennas 1452a through 1452r and the received signal from each antenna 1452 is provided to a respective receiver (RCVR) 1454a through 1454r. Each receiver 1454 conditions (e.g., filters, amplifies, and downconverts) a respective signal, digitizes the conditioned signal to provide samples, and further processes the samples to provide a corresponding “received” symbol stream.

An RX data processor 1460 can receive and process the N_{R} received symbol streams from N_{R} receivers 1454 based on a particular receiver processing technique to provide N_{T} “detected” symbol streams. RX data processor 1460 can demodulate, deinterleave, and decode each detected symbol stream to recover the traffic data for the data stream. The processing by RX data processor 1460 is complementary to that performed by TX MIMO processor 1420 and TX data processor 1414 at base station 1410.

A processor 1470 can periodically determine which precoding matrix to utilize as discussed above. Further, processor 1470 can formulate a reverse link message comprising a matrix index portion and a rank value portion.

The reverse link message can comprise various types of information regarding the communication link and/or the received data stream. The reverse link message can be processed by a TX data processor 1438, which also receives traffic data for a number of data streams from a data source 1436, modulated by a modulator 1480, conditioned by transmitters 1454a through 1454r, and transmitted back to base station 1410.

At base station 1410, the modulated signals from mobile device 1450 are received by antennas 1424, conditioned by receivers 1422, demodulated by a demodulator 1440, and processed by a RX data processor 1442 to extract the reverse link message transmitted by mobile device 1450. Further, processor 1430 can process the extracted message to determine which precoding matrix to use for determining the beamforming weights.

Processors 1430 and 1470 can direct (e.g., control, coordinate, manage, etc.) operation at base station 1410 and mobile device 1450, respectively. Respective processors 1430 and 1470 can be associated with memory 1432 and 1472 that store program codes and data. Processors 1430 and 1470 can also perform computations to derive frequency and impulse response estimates for the uplink and downlink, respectively.

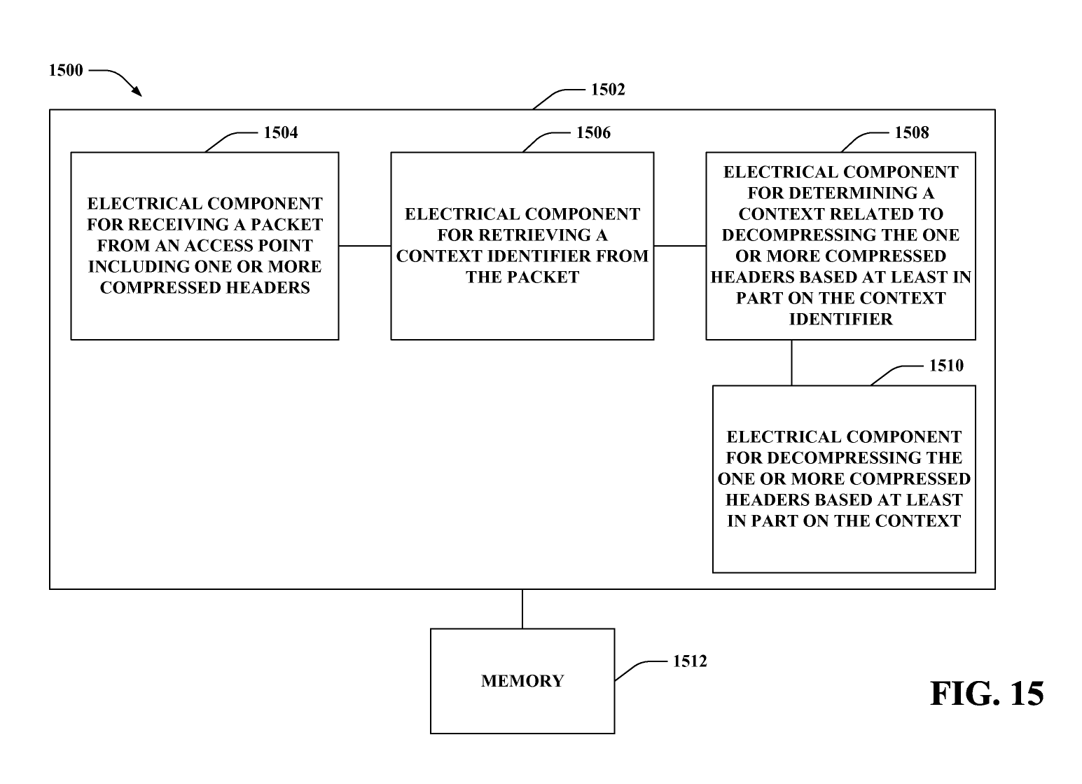

With reference to FIG. 15, illustrated is a system 1500 that facilitates decompressing packet headers for efficient relay communications. For example, system 1500 can reside at least partially within a base station, mobile device, etc. It is to be appreciated that system 1500 is represented as including functional blocks, which can be functional blocks that represent functions implemented by a processor, software, or combination thereof (e.g., firmware). System 1500 includes a logical grouping 1502 of electrical components that can act in conjunction. For instance, logical grouping 1502 can include an electrical component for receiving a packet from an access point including one or more compressed headers 1504. For example, as described, the packets can be compressed according to a specified compression algorithm, by removing static fields, etc. Additionally, logical grouping 1502 can include an electrical component for retrieving a context identifier from the packet 1506. As described, the context identifier can have been previously received from the access point (e.g., in an initial packet) and associated to a generated decompression context.

Moreover, logical grouping 1502 can include an electrical component for determining a context related to decompressing the one or more compressed headers based at least in part on the context identifier 1508. As described, for example, the context can have been previously generated from the initial packet to include at least a portion of one or more headers thereof (e.g., static fields that can be reinserted in compressed headers to decompress the headers, etc., as described), or other parameters for decompressing headers, as described. In addition, logical grouping 1502 can include an electrical component for decompressing the one or more compressed headers based at least in part on the context 1510. As described, electrical component 1510 can decompress headers based at least in part on a specified algorithm, parameters for inserting non-static data in previously stored static headers, inserting static fields in received non-static data, etc. Additionally, system 1500 can include a memory 1512 that retains instructions for executing functions associated with electrical components 1504, 1506, 1508, and 1510. While shown as being external to memory 1512, it is to be understood that one or more of electrical components 1504, 1506, 1508, and 1510 can exist within memory 1512.

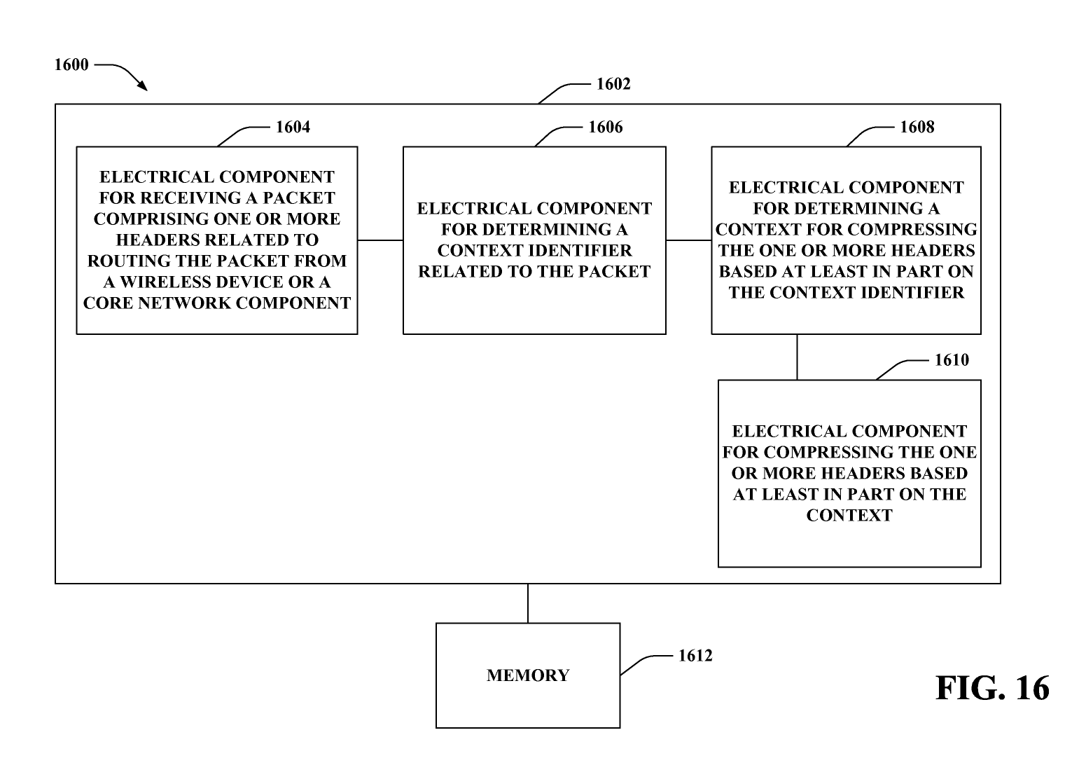

With reference to FIG. 16, illustrated is a system 1600 that facilitates compressing packet headers for efficient relay communications. For example, system 1600 can reside at least partially within a base station, mobile device, etc. It is to be appreciated that system 1600 is represented as including functional blocks, which can be functional blocks that represent functions implemented by a processor, software, or combination thereof (e.g., firmware). System 1600 includes a logical grouping 1602 of electrical components that can act in conjunction. For instance, logical grouping 1602 can include an electrical component for receiving a packet comprising one or more headers related to routing the packet from a wireless device or a core network component 1604. As described, for example, the one or more headers can include static fields that can be compressed for a given node to which the packet is routed. Additionally, logical grouping 1602 can include an electrical component for determining a context identifier related to the packet 1606. As described, for example, a context for compressing the packet can have previously been generated for a disparate packet from the wireless device or network component along with a context identifier, and electrical component 1606 can determine the context identifier based at least in part on the one or more headers (e.g., based at least in part on common static fields as the disparate packet).

Moreover, logical grouping 1602 can include an electrical component for determining a context for compressing the one or more headers based at least in part on the context identifier 1608. As described the context can be created based on the disparate packet to remove or otherwise compress static fields in headers of the disparate packet. In addition, the context can be associated with the context identifier for subsequently locating the context based at least in part on data in the one or more headers. In addition, logical grouping 1602 can include an electrical component for compressing the one or more headers based at least in part on the context 1610. Additionally, system 1600 can include a memory 1612 that retains instructions for executing functions associated with electrical components 1604, 1606, 1608, and 1610. While shown as being external to memory 1612, it is to be understood that one or more of electrical components 1604, 1606, 1608, and 1610 can exist within memory 1612.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions, procedures, etc. may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Furthermore, to the extent that the term “includes” is used in either the detailed description or the claims, such term is intended to be inclusive in a manner similar to the term “comprising” as “comprising” is interpreted when employed as a transitional word in a claim. Furthermore, although elements of the described aspects and/or aspects may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method, comprising:
receiving a packet from an access point including one or more compressed headers and a context identifier;
determining a context related to decompressing the one or more compressed headers based at least in part on the context identifier; and
decompressing the one or more compressed headers based at least in part on the context.

2. The method of claim 1, wherein the decompressing the one or more compressed headers includes inserting one or more static fields from the context in the one or more compressed headers.

3. The method of claim 1, further comprising:
receiving an initial packet from the access point including one or more headers and the context identifier, wherein the access point is a donor access point;
generating the context based at least in part on one or more parameters in the one or more headers; and
associating the context identifier to the context.

4. The method of claim 3, wherein the generating the context includes generating one or more parameters related to utilizing a decompression algorithm corresponding to a network specification.

5. The method of claim 3, wherein the generating the context includes storing the one or more headers of the initial packet with location information related to non-static data in the one or more headers to decompress headers.

6. The method of claim 3, wherein the generating the context includes storing static data from the one or more headers along with location information for inserting the static data in received non-static data to decompress headers.

7. The method of claim 1, further comprising:
determining a disparate context related to decompressing one or more disparate compressed headers of the packet based at least in part on the context identifier; and
decompressing the one or more disparate compressed headers based at least in part on the disparate context.

8. The method of claim 1, wherein the decompressing the one or more compressed headers includes decompressing at least a portion of non-static data in the one or more compressed headers.

9. The method of claim 8, wherein the decompressing at least the portion non-static data includes decompressing a general packet radio service (GPRS) tunneling protocol (GTP) sequence number according to a number of least significant bits of the GTP sequence number.

10. The method of claim 1, wherein the one or more compressed headers include at least one general packet radio service (GPRS) tunneling protocol (GTP) header and at least one internet protocol (IP) header.

11. A wireless communications apparatus, comprising:
at least one processor configured to:
obtain a packet from an access point including one or more compressed headers and a context identifier;
associate a context with the packet for decompressing the one or more compressed headers based at least in part on the context identifier; and
decompress the one or more compressed headers according to the context; and
a memory coupled to the at least one processor.

12. The wireless communications apparatus of claim 11, wherein the at least one processor decompresses the one or more compressed headers at least in part by inserting one or more static fields stored in the context in the one or more compressed headers.

13. The wireless communications apparatus of claim 11, wherein the at least one processor is further configured to:
obtain an initial packet from the access point including one or more headers and the context identifier;
create the context based at least in part on one or more parameters in the one or more headers; and
correlate the context identifier to the context.

14. The wireless communications apparatus of claim 13, wherein the at least one processor creates the context including the one or more parameters related to utilizing a decompression algorithm according to a network specification.

15. The wireless communications apparatus of claim 11, wherein the at least one processor is further configured to:
correlate a disparate context with the packet for decompressing one or more disparate compressed headers of the packet based at least in part on the context identifier; and
decompress the one or more disparate compressed headers according to the disparate context.

16. The wireless communications apparatus of claim 11, wherein the at least one processor is further configured to decompress at least a portion of non-static data in the one or more compressed headers.

17. An apparatus, comprising:
means for receiving a packet from an access point including one or more compressed headers;
means for retrieving a context identifier from the packet;
means for determining a context related to decompressing the one or more compressed headers based at least in part on the context identifier; and
means for decompressing the one or more compressed headers based at least in part on the context.

18. The apparatus of claim 17, wherein the means for decompressing the one or more compressed headers inserts one or more static fields from the context in the one or more compressed headers.

19. The apparatus of claim 17, wherein the means for receiving further receives an initial packet from the access point that comprises one or more headers, and the means for determining the context further generates the context based at least in part on one or more parameters in the one or more headers and associates the context identifier to the context.

20. The apparatus of claim 17, wherein the means for determining the context determines a disparate context related to decompressing one or more disparate compressed headers of the packet, and the means for decompressing decompresses the one or more disparate compressed headers based at least in part on the disparate context.

21. The apparatus of claim 17, wherein the means for decompressing decompresses the one or more compressed headers based further at least in part on decompressing at least a portion of non-static data in the one or more compressed headers.

22. A computer program product, comprising:
a computer-readable medium comprising:
code for causing at least one computer to obtain a packet from an access point including one or more compressed headers and a context identifier;
code for causing the at least one computer to associate a context with the packet for decompressing the one or more compressed headers based at least in part on the context identifier; and
code for causing the at least one computer to decompress the one or more compressed headers according to the context.

23. The computer program product of claim 22, wherein the code for causing the at least one computer to decompress decompresses the one or more compressed headers at least in part by inserting one or more static fields stored in the context in the one or more compressed headers.

24. The computer program product of claim 22, wherein the computer-readable medium further comprises:
code for causing the at least one computer to obtain an initial packet from the access point including one or more headers and the context identifier;
code for causing the at least one computer to create the context based at least in part on one or more parameters in the one or more headers; and
code for causing the at least one computer to correlate the context identifier to the context.

25. The computer program product of claim 24, wherein the code for causing the at least one computer to create the context creates the context including the one or more parameters related to utilizing a decompression algorithm according to a network specification.

26. The computer program product of claim 22, wherein the computer-readable medium further comprises:
code for causing the at least one computer to correlate a disparate context with the packet for decompressing one or more disparate compressed headers of the packet based at least in part on the context identifier; and
code for causing the at least one computer to decompress the one or more disparate compressed headers according to the disparate context.

27. The computer program product of claim 22, wherein the computer-readable medium further comprises code for causing the at least one computer to decompress at least a portion of non-static data in the one or more compressed headers.

28. An apparatus, comprising:
a packet communicating component that receives a packet from an access point including one or more compressed headers;
a context identifier determining component that retrieves a context identifier from the packet;
a decompression context associating component that determines a context related to decompressing the one or more compressed headers based at least in part on the context identifier; and
a header decompressing component that decompresses the one or more compressed headers based at least in part on the context.

29. The apparatus of claim 28, wherein the header decompressing component inserts one or more static fields from the context in the one or more compressed headers.

30. The apparatus of claim 28, wherein the packet communicating component further receives an initial packet from the access point that comprises one or more headers, and the decompression context associating component generates the context based at least in part on one or more parameters in the one or more headers and associates the context identifier to the context.

31. The apparatus of claim 28, wherein the decompression context associating component determines a disparate context related to decompressing one or more disparate compressed headers of the packet, and the header decompressing component decompresses the one or more disparate compressed headers based at least in part on the disparate context.

32. The apparatus of claim 28, wherein the header decompressing component decompresses the one or more compressed headers based further at least in part on decompressing at least a portion of non-static data in the one or more compressed headers.

33. A method, comprising:
receiving a packet comprising one or more headers related to routing the packet from a wireless device or a core network component;
determining a context identifier related to the packet;
selecting a context for compressing the one or more headers based at least in part on the context identifier; and
compressing the one or more headers based at least in part on the context.

34. The method of claim 33, wherein the compressing the one or more headers includes removing one or more static fields from the one or more headers and including the context identifier in the packet.

35. The method of claim 33, further comprising:
receiving an initial packet from the wireless device or the core network component;
generating the context for compressing headers based at least in part on a portion of one or more initial headers of the initial packet;
associating the context identifier with the context; and
communicating the context identifier and the initial packet to an access point.

36. The method of claim 35, wherein the generating the context includes generating one or more parameters related to a compression algorithm corresponding to a network specification.

37. The method of claim 35, wherein the generating the context includes storing the portion of one or more initial headers with location information related to non-static data in the portion of one or more initial headers for generating a compressed header.

38. The method of claim 35, wherein the generating the context includes storing static data from the portion of one or more initial headers along with location information for inserting the static data in received non-static data to generate a compressed header.

39. The method of claim 35, wherein the determining the context identifier includes receiving the context identifier from the wireless device or the core network component.

40. The method of claim 33, wherein the compressing the one or more headers includes compressing at least a portion of non-static data in the one or more headers.

41. The method of claim 40, wherein the compressing at least the portion non-static data includes compressing a general packet radio service (GPRS) tunneling protocol (GTP) sequence number according to a number of least significant bits of the GTP sequence number.

42. The method of claim 33, wherein the one or more headers include at least one general packet radio service (GPRS) tunneling protocol (GTP) header and at least one internet protocol (IP) header.

43. A wireless communications apparatus, comprising:
at least one processor configured to:
obtain a packet comprising one or more headers for routing the packet among one or more relay nodes from a wireless device or a core network component;
determine a context identifier related to the packet;
discern a context for compressing the one or more headers based at least in part on the context identifier; and
compress the one or more headers based at least in part on the context; and
a memory coupled to the at least one processor.

44. The wireless communications apparatus of claim 43, wherein the at least one processor compresses the one or more headers at least in part by removing one or more static fields from the one or more headers and including the context identifier in the packet.

45. The wireless communications apparatus of claim 43, wherein the at least one processor is further configured to:
obtain an initial packet from the wireless device or the core network component comprising one or more initial headers;
create the context for compressing headers based at least in part on a portion of the one or more initial headers;
associate the context identifier with the context; and
provide the context identifier and the initial packet to an access point.

46. The wireless communications apparatus of claim 45, wherein the at least one processor is further configured to receive the context identifier from the wireless device or the core network component.

47. The wireless communications apparatus of claim 43, wherein the at least one processor compresses the one or more headers at least in part by compressing at least a portion of non-static data in the one or more headers.

48. An apparatus, comprising:
means for receiving a packet comprising one or more headers related to routing the packet from a wireless device or a core network component;
means for determining a context identifier related to the packet;
means for selecting a context for compressing the one or more headers based at least in part on the context identifier; and
means for compressing the one or more headers based at least in part on the context.

49. The apparatus of claim 48, wherein the means for compressing compresses the one or more headers at least in part by removing one or more static fields from the one or more headers and including the context identifier in the packet.

50. The apparatus of claim 48, wherein the means for receiving the packet further receives an initial packet from the wireless device or the core network component, the means for determining the context further generates the context based at least in part on a portion of one or more initial headers in the initial packet, and the means for determining the context identifier associates the context identifier to the context.

51. The apparatus of claim 50, wherein the means for receiving the packet communicates the initial packet and the context identifier to an access point.

52. The apparatus of claim 50, wherein the means for receiving further receives the context identifier from the wireless device or the core network component.

53. The apparatus of claim 48, wherein the means for compressing the one or more headers further compresses at least a portion of non-static data in the one or more headers.

54. A computer program product, comprising:
a computer-readable medium comprising:
code for causing at least one computer to obtain a packet comprising one or more headers for routing the packet among one or more relay nodes from a wireless device or a core network component;
code for causing the at least one computer to determine a context identifier related to the packet based at least in part on the one or more headers;
code for causing the at least one computer to discern a context for compressing the one or more headers based at least in part on the context identifier; and
code for causing the at least one computer to compress the one or more headers based at least in part on the context.

55. The computer program product of claim 54, wherein the code for causing the at least one computer to compress compresses the one or more headers at least in part by removing one or more static fields from the one or more headers and including the context identifier in the packet.

56. The computer program product of claim 54, wherein the computer-readable medium further comprises:
code for causing the at least one computer to obtain an initial packet from the wireless device or the core network component comprising one or more initial headers;
code for causing the at least one computer to create the context for compressing headers based at least in part on a portion of the one or more initial headers;
code for causing the at least one computer to associate the context identifier with the context; and
code for causing the at least one computer to provide the context identifier and the initial packet to an access point.

57. The computer program product of claim 56, wherein the computer-readable medium further comprises code for causing the at least one computer to receive the context identifier from the wireless device or the core network component.

58. The computer program product of claim 54, wherein the code for causing the at least one computer to compress compresses the one or more headers at least in part by compressing at least a portion of non-static data in the one or more headers.

59. An apparatus, comprising:
a packet communicating component that receives a packet comprising one or more headers related to routing the packet from a wireless device or a core network component;
a context identifier determining component that obtains a context identifier for the packet;
a compression context associating component that discerns a context for compressing the one or more headers based at least in part on the context identifier; and
a header compressing component that compresses the one or more headers based at least in part on the context.

60. The apparatus of claim 59, wherein the header compressing component compresses the one or more headers at least in part by removing one or more static fields from the one or more headers and including the context identifier in the packet.

61. The apparatus of claim 59, wherein the packet communicating component further receives an initial packet from the wireless device or the core network component, the compression context associating component further generates the context based at least in part on a portion of one or more initial headers in the initial packet, and the context identifier determining component associates the context identifier with the context.

62. The apparatus of claim 61, wherein the packet communicating component further transmits the context identifier and the initial packet to an access point.

63. The apparatus of claim 61, wherein the packet communicating component further receives the context identifier from the wireless device or the core network component.

64. The apparatus of claim 59, wherein the header compressing component further compresses at least a portion of non-static data in the one or more headers.
